(19) United States
(12) Patent Application Publication
(10) Pub. No.: US 2009/0037223 A1
(43) Pub. Date: Feb. 5, 2009

(54) System and method for accessing patient history information in a health services environment using a human body graphical user interface

(75) Inventors: Jason Reinis Green, Ponte Vedra, FL (US); Robert John Snyder, Ponte Vedra, FL (US); Billy W H A Steeghs, Ponte Vedra, FL (US)

Correspondence Address: BUCHANAN, INGERSOLL & ROONEY PC, POST OFFICE BOX 1404, ALEXANDRIA, VA, 22313-1404, US

(73) Assignee: Medical Development International Ltd. Inc., Ponte Vedra Beach, FL (US)

(21) Appl. No.: 11/979,528

(22) Filed: Nov. 5, 2007

Related U.S. Application Data
(60) Provisional application No. 60/935,238, filed on Aug. 1, 2007.

(51) Int. Cl. G06Q 50/00

(52) U.S. Cl. 705/3; 705/2

(57) ABSTRACT

Methods and systems for accessing patient history information in a health services environment using a human body graphical user interface are presented. An exemplary computer-implemented method for accessing patient history information includes identifying established medical codes, which are associated with portions of the human body, from patient history information for a patient; mapping the patient history information to corresponding portions of the human body based on the identified established medical codes; and displaying the patient history information for the patient in accordance with the mapping using a human body graphical user interface (GUI). The human body GUI comprises an anatomical representation of the human body that graphically depicts a plurality of portions of the human body associated with the established medical codes.

### CROSS-REFERENCE TO RELATED APPLICATIONS

This application claims the benefit of U.S. Provisional Patent Application No. 60/935,238, filed Aug. 1, 2007, which is herein incorporated by reference in its entirety. This application is related to U.S. patent application Ser. No. 11/725,491, filed Mar. 20, 2007, which is a continuation-in-part application of U.S. patent application Ser. No. 11/412,836, filed Apr. 28, 2006, both of which are herein incorporated by reference in their entireties.

### BACKGROUND

Conventional systems and methods for processing claims in a health services environment do not readily detect errors and acts of fraud, particularly with respect to medical services that were not performed, incorrectly coded, coded against the wrong patient, etc. Typically, the scheduling of appointments, receiving of claims, and validating and payment of claims are performed by different specialized entities as disparate processes in a serial workflow, in which data is passed from one entity to another, often resulting in claims and payments being delayed or even lost. Furthermore, conventional claims processing systems and methods rely on validating received claims by manually checking for inconsistencies or other indicators that the claim is invalid, duplicative, in error, or fraudulent. This prior process is time consuming and prone to errors, resulting in received claims being substantially delayed in payment, not being paid correctly, or being paid without assurance as to whether the received claim is a valid claim.

Additionally, medical care history information on a patient typically comprises paper-based content that is stored in a file folder created for the patient at a service provider's office, in which case the service provider must access the file folder and read the information on a particular patient. Even if the medical care history information on the patient is stored electronically, the electronic data is typically accessible in a text format. Thus, whether the medical care history information on the patient comprises paper-based or electronic content, the service provider must typically read the content to ascertain the patient's care history.

### SUMMARY

A system and method for accessing patient history information in a health services environment using a human body graphical user interface are presented.

An exemplary computer-implemented method for accessing patient history information includes: identifying established medical codes, which are associated with portions of the human body, from patient history information for a patient; mapping the patient history information to corresponding portions of the human body based on the identified established medical codes; and displaying the patient history information for the patient in accordance with the mapping using a human body graphical user interface (GUI). The human body GUI comprises an anatomical representation of the human body that graphically depicts a plurality of portions of the human body associated with the established medical codes.

An exemplary computer-implemented system for accessing patient history information includes: means for identifying established medical codes, which are associated with portions of the human body, from patient history information for a patient; means for mapping the patient history information to corresponding portions of the human body based on the identified established medical codes; and means for displaying the patient history information for the patient in accordance with the mapping using a human body GUI. The human body GUI comprises an anatomical representation of the human body that graphically depicts a plurality of portions of the human body associated with the established medical codes.

### BRIEF DESCRIPTION OF THE DRAWINGS

Other objects and advantages of the invention will become apparent to those skilled in the relevant art(s) upon reading the following detailed description of preferred embodiments, in conjunction with the accompanying drawings, in which like reference numerals have been used to designate like elements, and in which:

FIGS. 1-8 illustrate process flowcharts providing exemplary steps for determining the appropriateness of service provider claims for payment;

FIG. 9 illustrates an exemplary high-level network for implementing a system for determining the appropriateness of service provider claims for payment;

FIGS. 10A-10Z illustrate screen captures of an exemplary implementation of the systems and methods described herein for determining the appropriateness of service provider claims for payment, in the context of providing health care services to inmate patients in a correctional institution;

FIG. 11 illustrates a process flowchart providing exemplary steps for tracking treatment of patients;

FIGS. 12A-12C illustrate screen captures of an exemplary implementation of the systems and methods described herein for tracking treatment of patients in the context of providing health care services to inmate patients in a correctional institution;

FIG. 13 illustrates a process flowchart providing exemplary steps for accessing patient history information using a human body graphical user interface;

FIG. 14 illustrates a hierarchy of patient history information;

FIG. 15 illustrates an exemplary human body GUI that graphically depicts portions of the human body;

FIG. 16 illustrates a zoom-level human body GUI of a selectable portion of the human body GUI illustrated in FIG. 15;

FIG. 17 illustrates a GUI showing multiple instances of the human body GUI for a patient, where each of the instances corresponds to a predetermined period of time during an episode of care;

FIG. 18 illustrates a human body GUI for a population of patients, where a cumulative representation of the patient history information for the patients within the patient population is indicated on the portions of the human body GUI;

FIG. 19 illustrates a zoom-level human body GUI of a selectable portion of the human body GUI illustrated in FIG. 18;

FIG. 20 illustrates a system diagram of an exemplary patient history information subscription service; and

FIGS. 21A-21D illustrate screen captures of an exemplary implementation of the systems and methods described herein for accessing patient history information using a human body GUI.

### DETAILED DESCRIPTION

A detailed description of methods and systems for determining the appropriateness of service provider claims for payment and for tracking treatment of patients in a health services environment is presented below, followed by a detailed description of systems and methods for accessing patient history information in a heath services environment using a human body graphical user interface. The explanation will be by way of exemplary embodiments to which the present invention is not limited.

### Methods and Systems for Determining the Appropriateness of Service Provider Claims and for Tracking Treatment of Patients

By integrating the scheduling of appointments with service providers with the processing of claims from the service providers for services rendered, the systems and methods described herein may yield many advantages over systems and methods specializing in any one these aspects alone. By gathering information from inception to completion for any particular appointment, the systems and methods described herein are capable of rendering payment to the service providers in a more timely and accurate fashion. In particular, by generating information about each scheduled appointment, an approximate type and number of claims that should be received from service providers for each scheduled appointment can be estimated. In this way, a particular claim can be reviewed with greater accuracy when an appointment that corresponds to the claim is identified. The systems and methods described herein can, in some embodiments, automatically match scheduled appointments to received claims with high speed and accuracy thereby reducing the risk of payment of erroneous, duplicate, or fraudulent claims; however, in other embodiments, claims need not all be matched to scheduled appointments in order to be processed. Furthermore, proper payment of all anticipated claims for a particular appointment can be better ensured using certain aspects of exemplary embodiments. For example, because the systems and methods described herein can automatically identify appointments for which no claims have been received, the service providers can be contacted and prompted to submit the outstanding claims. Thus, institutions are less likely to pay for the claims that they should not pay, and the service providers rendering the services are more likely to be paid for all of the claims for which they should be paid.

Process Overview

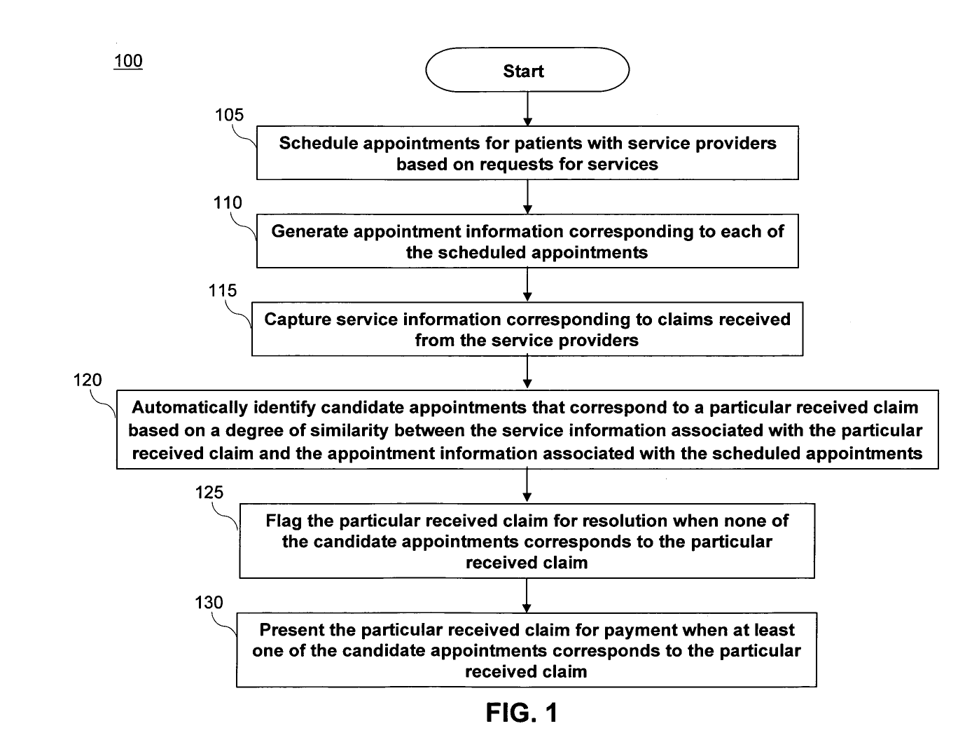

FIGS. 1-8 and FIG. 11 illustrate exemplary steps for a process 100 for determining the appropriateness of service provider claims for payment and for tracking treatment of patients. Not all of the steps of the figures have to occur in the order shown, as will be apparent to persons skilled in the relevant art(s) based on the teachings herein. Other operational and structural embodiments will be apparent to persons skilled in the relevant art(s) based on the following discussion. These steps are described in detail below.

First, in step 105, appointments for patients are scheduled with service providers based on requests for services. For example, when a client institution has a patient in need of health care services, the client institution securely forwards information about the patient and the desired appointment to a scheduler in the form of an electronic request.

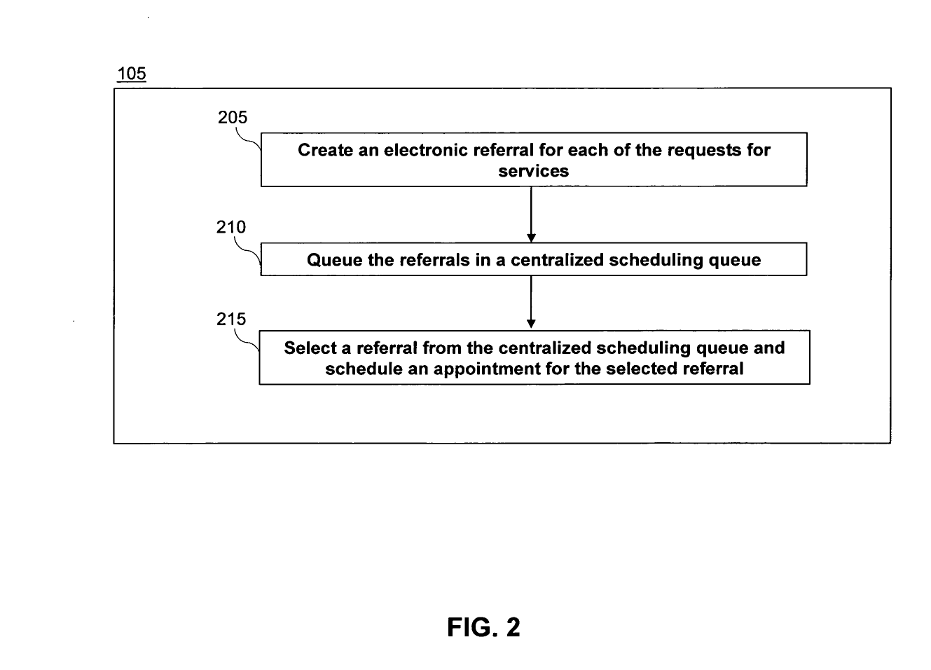

FIG. 2 illustrates detailed steps for executing step 105. In step 205, an electronic referral is created for each of the requests. While electronic referrals are preferred, they can be created in non-electronic format. Although, eventually the information from a non-electronic referral would likely be captured electronically, either in the form of an image of the non-electronic referral or, in other circumstances, the information would be keyed in from the non-electronic referral. As will be described in more detail below with respect to the detailed description of the exemplary implementation, each electronic referral includes the patient and desired appointment information supplied by the client institution, in addition to contact information for the client institution (usually for the contract manager) and for the primary scheduler. It may also capture the reasons for the referral, the types of services expected to be rendered (e.g., blood tests), or the circumstances for the referral (e.g., the patient has a medical condition such as diabetes). This referral may be generated by a doctor or clinician or, in some circumstances, by the patient (e.g., preferred provider organizations (PPOs)).

Each electronic referral is assigned a unique referral identification code and, in step 210, the referrals are queued in a centralized scheduling queue of a scheduling module. In step 215, a scheduler selects a referral from the centralized scheduling queue and schedules an appointment for the selected referral. In most instances, the scheduler is a person. Additionally, in most cases, the scheduler will schedule the appointment with a service provider(s) identified in a particular network of service providers associated with the client institution. Typically, the scheduler will schedule the appointment by telephoning or otherwise communicating directly with the service provider. In the event that there is no provider in the network for a particular requested service, the scheduler can attempt to recruit a service provider in the required specialty and negotiate a single-patient agreement for the appointment. When scheduling an appointment, the scheduler may take into consideration any predefined scheduling rules for the client institution and/or service provider (e.g., a scheduling rule for a correctional institution might specify that only one maximum security inmate patient can be at an off-site appointment at a time).

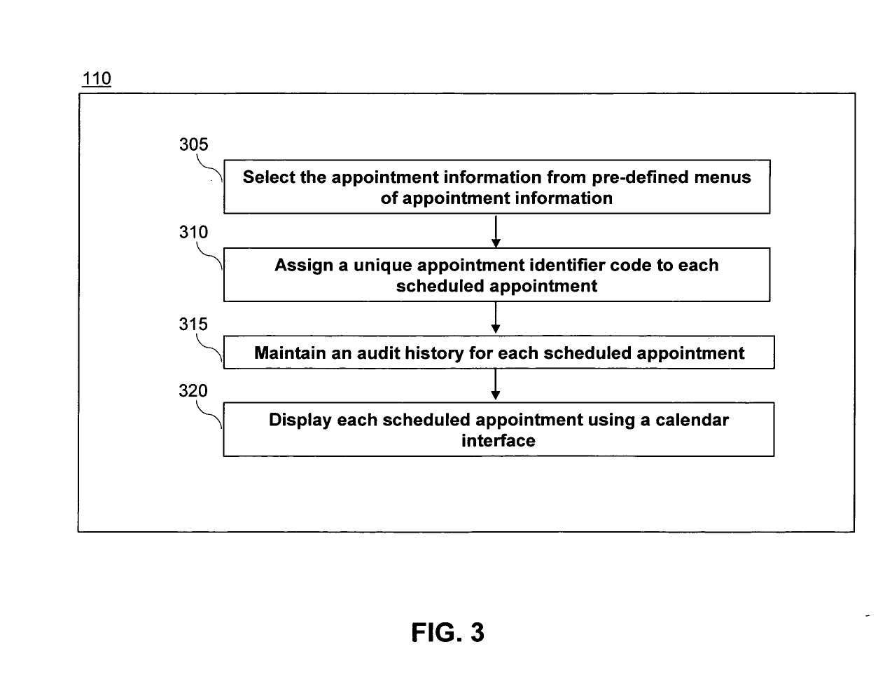

Next, in step 110, appointment information corresponding to each of the scheduled appointments is generated. FIG. 3 illustrates detailed steps for executing step 110. As will be described in more detail below with respect to the detailed description of the exemplary implementation, in step 305, the scheduler (or other user) views an electronic referral and can select corresponding appointment information from predefined menus of appointment information (e.g., service provider, appointment date, appointment time, etc.). In one embodiment, the scheduler/user selects a unique service identifier code for each requested service that can be used as a cross-check against Medicare-defined service codes to validate received claims in subsequent steps. Some appointment information may be manually keyed in by the scheduler/user, in which case a double-blind entry process can be implemented to detect and correct keying errors. The double-blind entry process entails two data entry people entering the same information, but “blind” to each other. Discrepancies are then identified and resolved, usually by a third person, particularly when the discrepancy is not automatically resolvable through spell-checker or grammar-checker software components. Additionally, the scheduler/user can use the scheduling module to attach associated information files (e.g., x-ray films) as appointment information.

In step 310, a unique appointment identifier code can be assigned to each of the scheduled appointments that can be used to link appointments with received claims in subsequent steps. Advantageously, in step 315, an audit history can be maintained for each of the scheduled appointments to track when each appointment was created, modified, canceled, etc. In step 320, each scheduled appointment can be displayed using a calendar interface such that a user (e.g., the client institution, the scheduler, the service provider, etc.) can select a displayed scheduled appointment to access corresponding appointment information, perhaps each user potentially having different access rights to different types of appointment information.

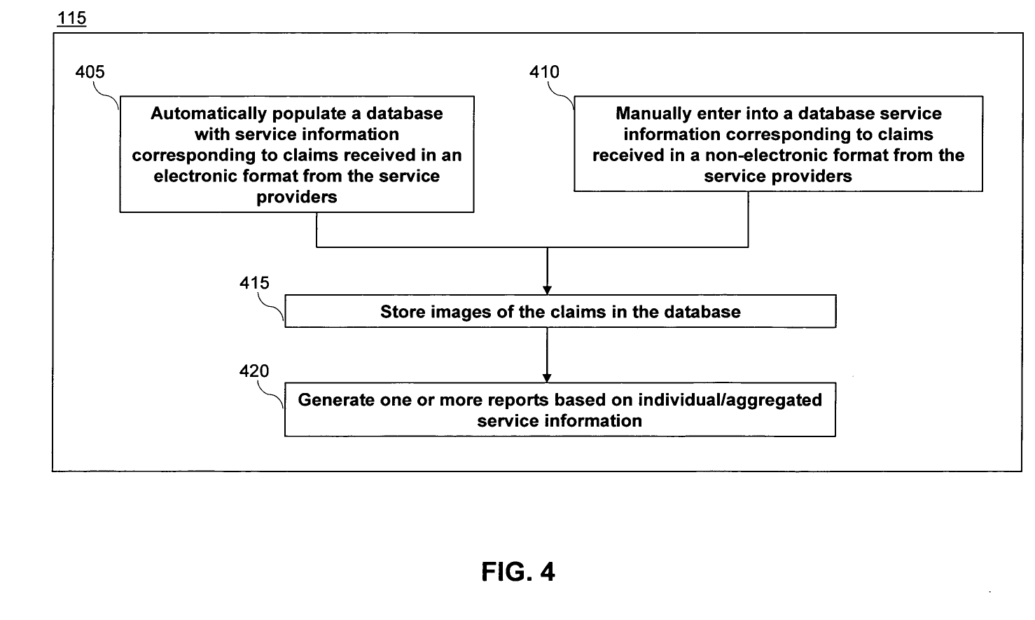

In step 115, service information is captured that corresponds to claims received from the service providers for payment of charges associated with services rendered by the service providers to the patients. FIG. 4 illustrates detailed steps for executing step 115. In step 405, a service information database may be automatically populated with service information corresponding to claims received in an electronic format from the service providers. In step 410, the database may be manually populated with service information corresponding to claims received in a non-electronic format from the service providers. In this latter case, the service information can be keyed into the database in accordance with the double-blind entry process described above to detect and correct keying errors. In step 415, images of the claims can be stored in the database. Claims received in non-electronic format can be scanned to generate the claim images.

Optionally, in step 420, one or more reports can be generated based on individual or aggregated service and/or appointment information, such as predefined institution-specific reports, financial reports, contract reports, and utilization reports. In an embodiment, step 420 includes ad hoc report generation. In another embodiment, step 420 includes generating a pricing service sheet that identifies a pricing structure for a particular network of service providers.

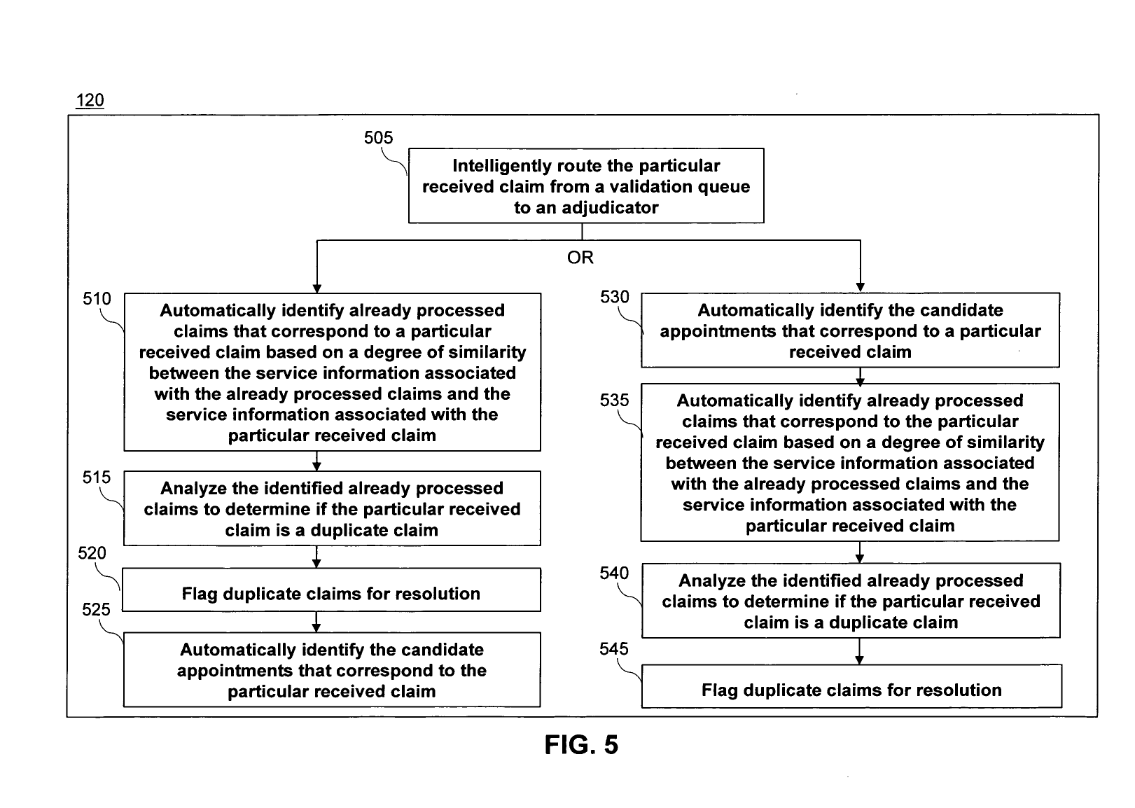

In step 120, the process 100 further includes automatically identifying, using logic, fuzzy logic and/or artificial intelligence (AI), candidate appointments that correspond to a particular received claim based on a degree of similarity between the service information associated with the particular received claim and the appointment information associated with the scheduled appointments. Any suitable logic, fuzzy logic, or AI system could be used and would likely be centrally optimized for circumstances, particularly if the circumstances are dynamic. FIG. 5 illustrates detailed steps for executing step 120. In step 505, the particular received claim is intelligently routed from an adjudication queue of received claims to an adjudicator. In an embodiment, the particular received claim is routed to an initial adjudicator that is determined to be available, and if the initial adjudicator does not respond within a predetermined period of time, the particular received claim is routed to another available adjudicator so that the received claims do not lag in the adjudication queue.

Next, either steps 510-525 are performed or steps 530-545 are performed. In the first case, a duplicate check is performed in steps 510-520 before an appointment match is performed in step 525. In particular, in step 510, already processed claims that correspond to a particular received claim are automatically identified using logic, fuzzy logic and/or AI based on a degree of similarity between the service information associated with the already processed claims and the service information associated with the particular received claim. In step 515, the identified already processed claims are analyzed to determine if the particular received claim is a duplicate of any of the identified already processed claims. In an embodiment, step 515 includes having the adjudicator analyze the identified already processed claims to determine if the service provider submitted a duplicate claim. In another embodiment, step 515 includes automatically determining if the service provider submitted a duplicate claim. In step 520, duplicate claims are flagged for resolution.

Alternatively, in the latter case, after an appointment match is performed in step 530, a duplicate match is performed in steps 535-545. In particular, in step 535, already processed claims that correspond to a particular received claim are automatically identified using logic, fuzzy logic and/or AI based on a degree of similarity between the service information associated with the already processed claims and the service information associated with the particular received claim. In step 540, the identified already processed claims are analyzed to determine if the particular received claim is a duplicate claim. In an embodiment, step 540 includes having the adjudicator analyze the identified already processed claims to determine if the service provider submitted a duplicate claim. In another embodiment, step 540 includes automatically determining if the service provider submitted a duplicate claim. In step 545, duplicate claims are flagged for resolution.

In an embodiment, steps 525 and 530 include displaying the candidate appointments for review by an adjudicator. The adjudicator can then determine whether to flag the particular received claim for resolution or to present the particular received claim for payment. In another embodiment, steps 525 and 530 include only displaying for review by an adjudicator candidate appointments that do not directly correspond to the particular received claim. In this case, candidate appointments that directly correspond to the particular received claim may not be displayed for review by the adjudicator to further expedite the validation process.

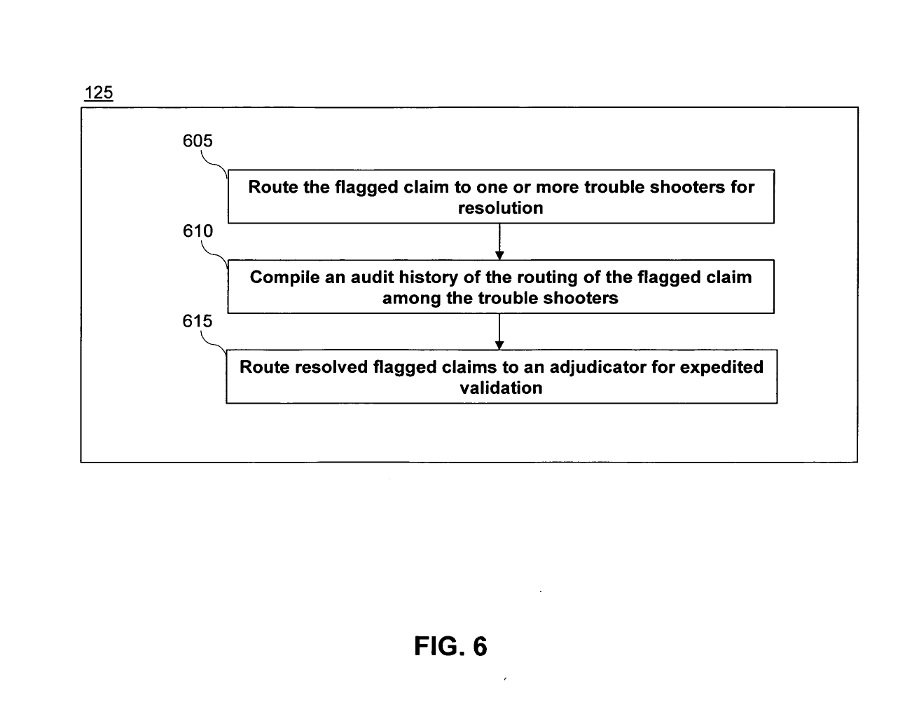

In step 125 of the process 100, the particular received claim is flagged for resolution when none of the candidate appointments corresponds to the particular received claim. FIG. 6 illustrates detailed steps for executing step 125. In step 605, the flagged claim is routed to one or more trouble shooters for resolution (e.g., to the contract manager for pricing problems, to the service provider for duplicate claims, etc.). This process of routing flagged claims among trouble shooters is described in more detail below with respect to the detailed description of the exemplary implementation. Essentially, instead of flagged claims lagging in the adjudication queue, the flagged claim is advantageously routed among various trouble shooters to address the problem with the flagged claim, or at least to identify where resolution has been stymied. In step 610, an audit history of the routing of the flagged claim among the trouble shooters is compiled. Compiling an audit history can be advantageous for motivating faster resolution by the trouble shooters of the problem associated with the flagged claim. In step 615, resolved flagged claims are routed to an adjudicator for expedited validation. In one embodiment, the resolved claims can be routed to the top of the adjudication queue so that they are adjudicated as quickly as possible following resolution.

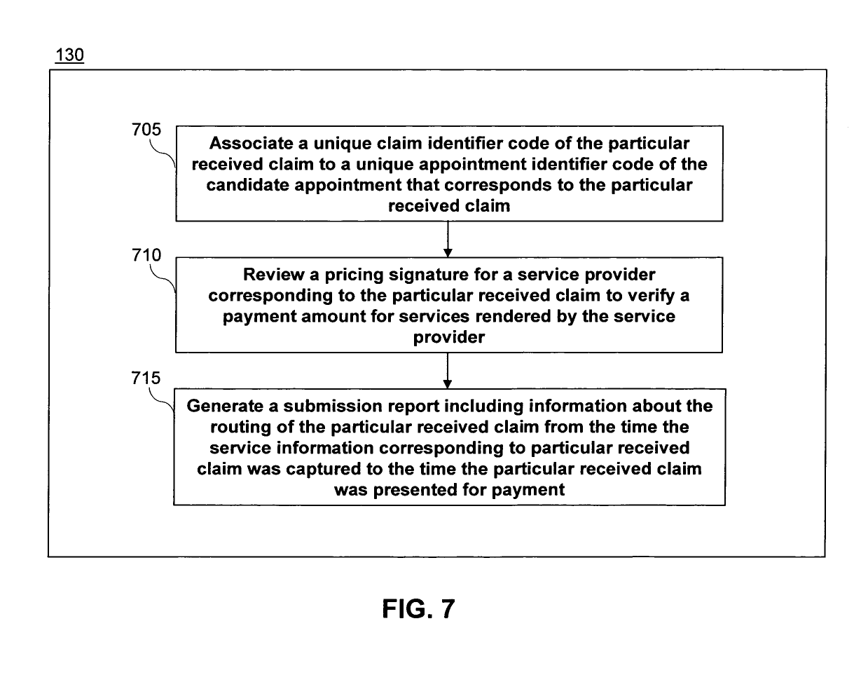

In step 130, the particular received claim is presented for payment when at least one of the candidate appointments corresponds to the particular received claim. FIG. 7 illustrates detailed steps for executing step 130. In step 705, a unique claim identifier code of the particular received claim can be associated with a unique appointment identifier code of the candidate appointment that corresponds to the particular received claim. In this way, the candidate appointment and its associated appointment information can be electronically linked to the particular received claim and its corresponding service information. In step 710, a pricing signature for a service provider corresponding to the particular received claim can be reviewed to verify a payment amount for services rendered by the service provider. The “pricing signature” refers to unique information associated with the service provider that assists in verifying the correct pricing. In step 715, a submission report can be generated that includes information about the routing of the particular received claim from the time the service information corresponding to particular received claim was captured to the time the particular received claim was presented for payment. The submission report can then be forwarded to the client institution. In an embodiment, the submission report is electronically forwarded to the client institution and includes selectable links to related appointment and/or service information.

In an embodiment, steps 125 and 130 include automatically flagging the particular received claim for resolution when none of the candidate appointments corresponds to the particular received claim, and automatically presenting the particular received claim for payment when at least one of the candidate appointments corresponds to the particular received claim, respectively, to expedite the validation process.

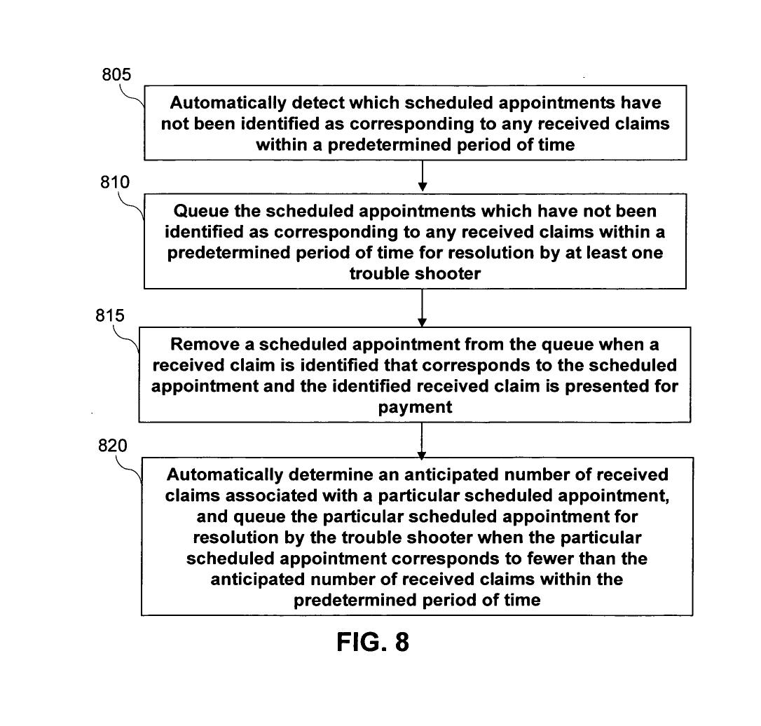

Optionally, the process 100 depicted in FIGS. 1-7 includes the additional steps shown in FIG. 8. In step 805, scheduled appointments that have not been identified as corresponding to any received claims within a predetermined period of time can be automatically detected. In step 810, the scheduled appointments which have not been identified as corresponding to any received claims within a predetermined period of time can be queued for resolution by at least one trouble shooter. The trouble shooter can then contact the service provider(s) associated with the scheduled appointment and request that a claim be submitted for payment. In step 815, a scheduled appointment is removed from the queue when a received claim is identified that corresponds to the scheduled appointment and the identified received claim is presented for payment. In this way, the service providers are more likely to receive payment for all of the claims they are entitled to. Furthermore, if the service providers are promptly paid, they are more likely to contract with the client institutions to provide health care services.

In step 820, an anticipated number of received claims associated with a particular scheduled appointment can be automatically determined, and the particular scheduled appointment can be queued for resolution by the trouble shooter when the particular scheduled appointment corresponds to fewer than the anticipated number of received claims within the predetermined period of time. In this way, the particular scheduled appointment can be analyzed on a procedure or service basis to estimate how many claims are anticipated to be received from the service providers after the appointment occurs. When fewer than the anticipated number of claims is received within a predetermined period after the appointment occurs, the trouble shooter can contact the applicable service provider(s) and request that the missing claims be submitted for payment.

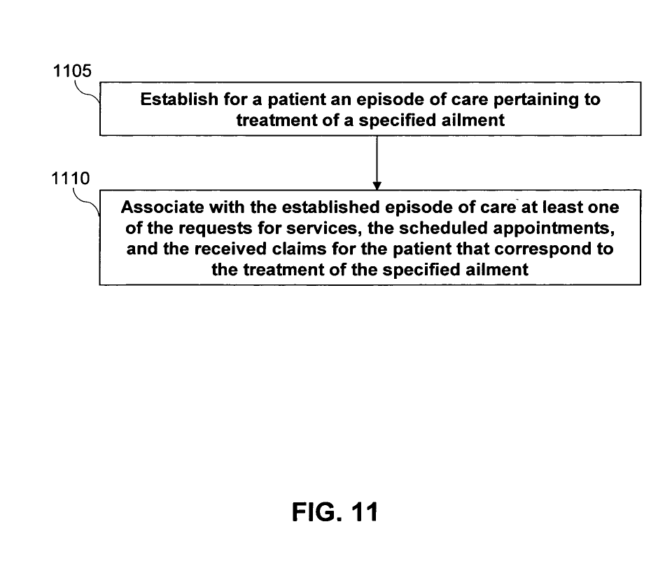

Optionally, the process 100 includes the additional steps shown in FIG. 11. FIG. 11 illustrates exemplary steps for tracking treatment of patients. In step 1105, an episode of care pertaining to treatment of a specified ailment is established for a patient, and in step 1110, the requests for services, the scheduled appointments, and the received claims for the patient that correspond to the treatment of the specified ailment are associated with the established episode of care. In this way, a user can track the treatment of the patient for the specified ailment from start-to-finish, enabling the user to determine an overall cost of the treatment. Additionally, the user can track the costs associated with the treatment of particular health problems.

System Overview

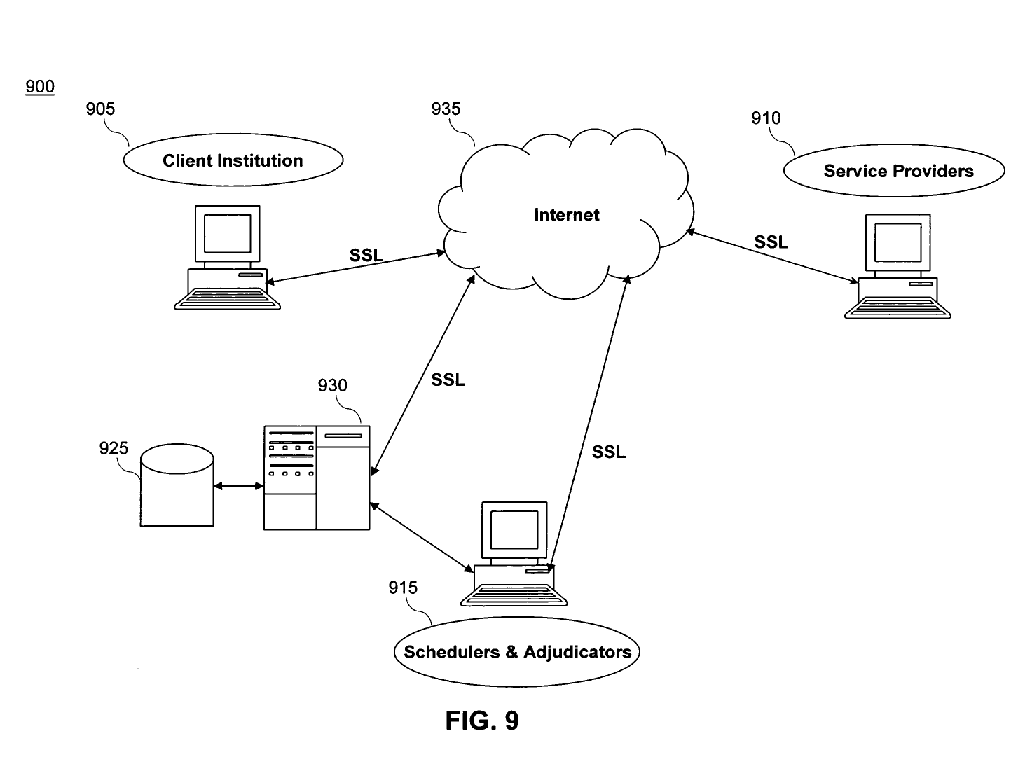

FIG. 9 illustrates an exemplary high-level network 900 for implementing a system for determining the appropriateness of service provider claims for payment. As shown in FIG. 9, the system can be employed in conjunction with a computer-based system, where the elements can be implemented in hardware, software, firmware, or combinations thereof. Network 900 includes client institution workstations 905, service provider workstations 910, and scheduler and adjudicator workstations 915. Each of the workstations is configured to communicate with an application server 930 via Secure Sockets Layer (SSL) internet connections 935. As shown in FIG. 9, the schedulers and adjudicators 915 can also access application server 930 via a secure closed network connection.

The server 930 includes processors and memory for hosting different modules, which are described in more detail below with respect to the detailed description of the exemplary implementation. Briefly, the system for determining the appropriateness of service provider claims for payment includes a scheduling module configured to schedule appointments for patients with the service providers 910 based on requests for services from the client institution 905, and generate appointment information corresponding to each of the scheduled appointments. The appointment information can be stored in a database 925.

The system further includes a claim intake module configured to receive claims from the service providers 910 for payment of charges associated with services rendered by the service providers 910 to the patients and capture service information corresponding to each of the received claims. The service information can also be stored in database 925.

The system also includes an adjudication module configured to automatically identify candidate appointments that correspond to a particular received claim based on a degree of similarity between the service information associated with the particular received claim and the appointment information associated with the scheduled appointments. The adjudication module is further configured to present the particular received claim for payment when at least one of the candidate appointments corresponds to the particular received claim and flag the particular received claim for resolution when none of the candidate appointments corresponds to the particular received claim.

Detailed Description of Exemplary Implementations

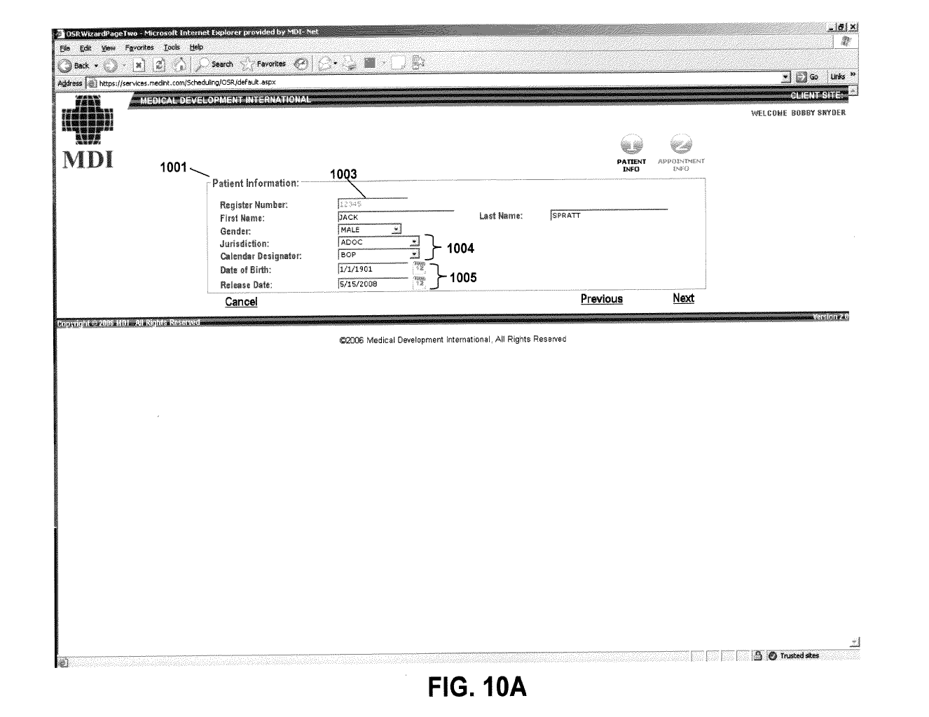

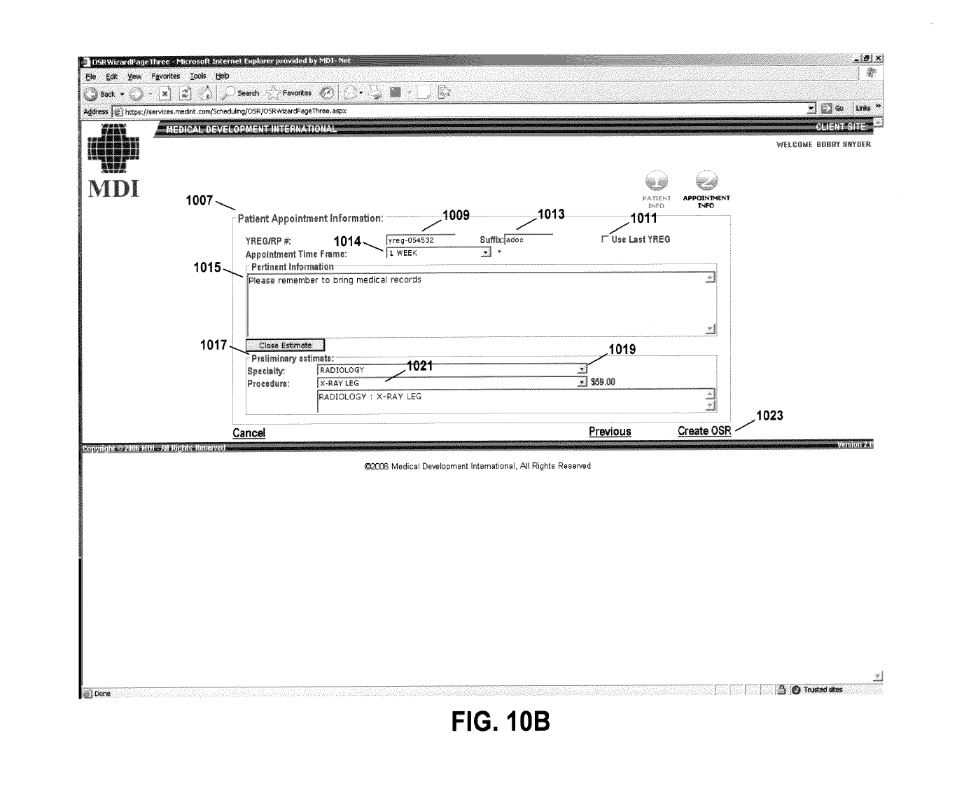

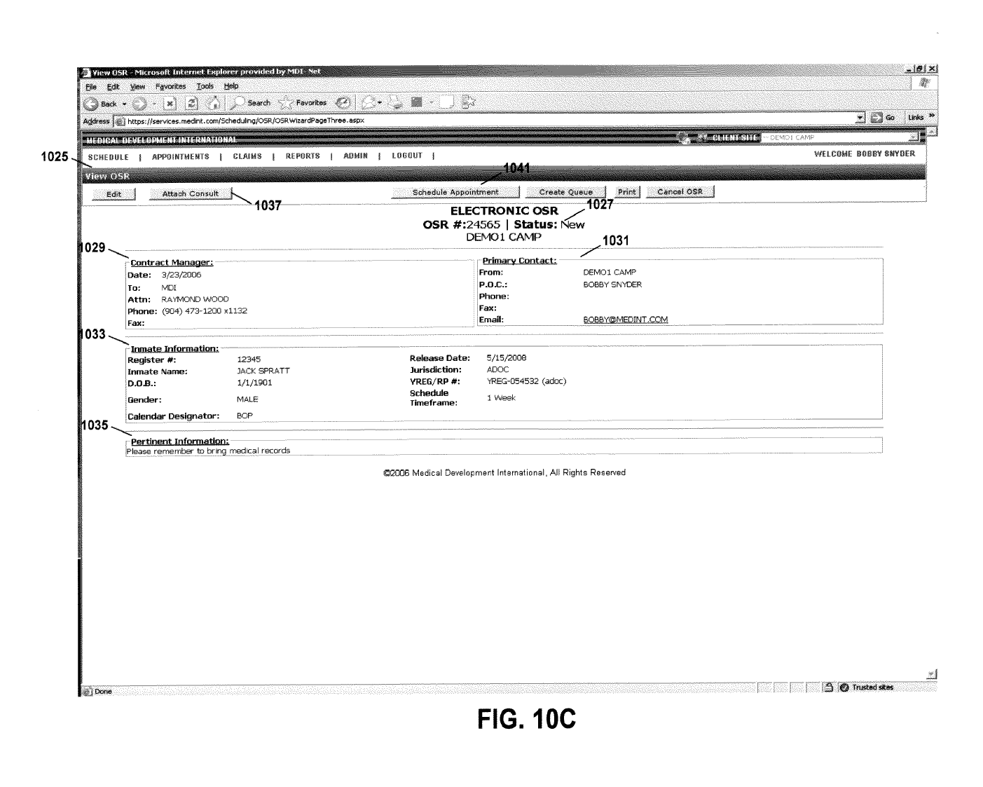

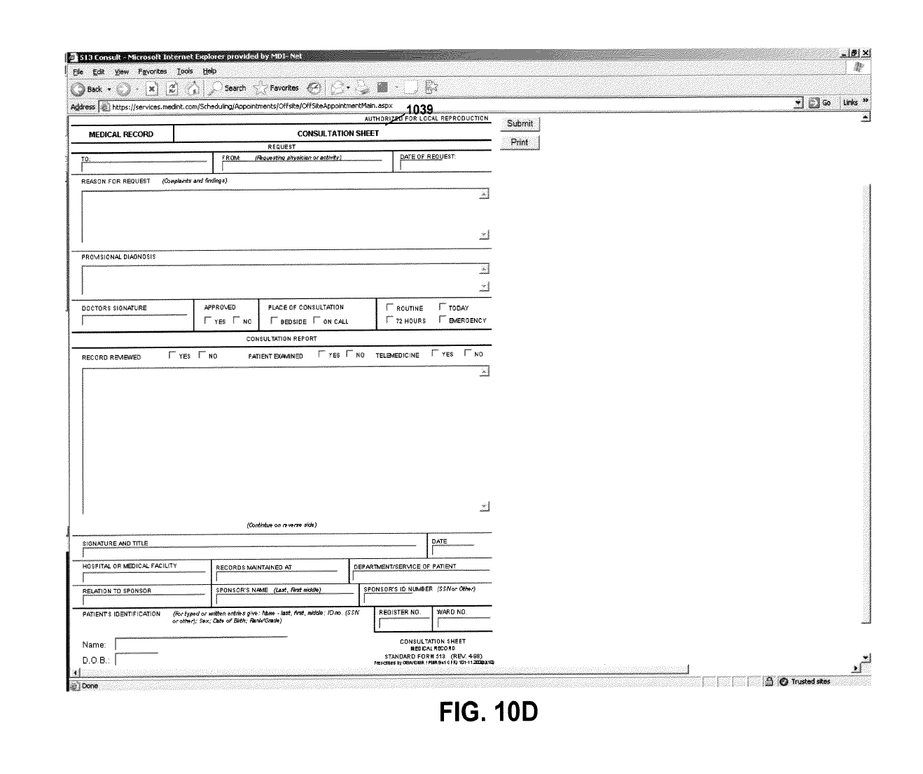

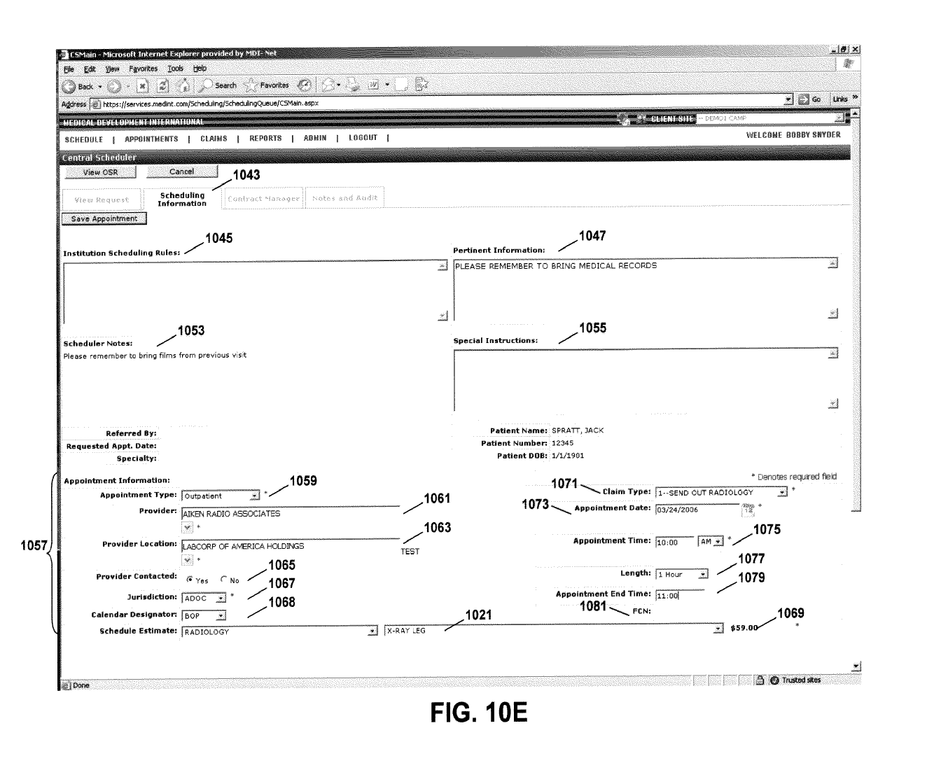

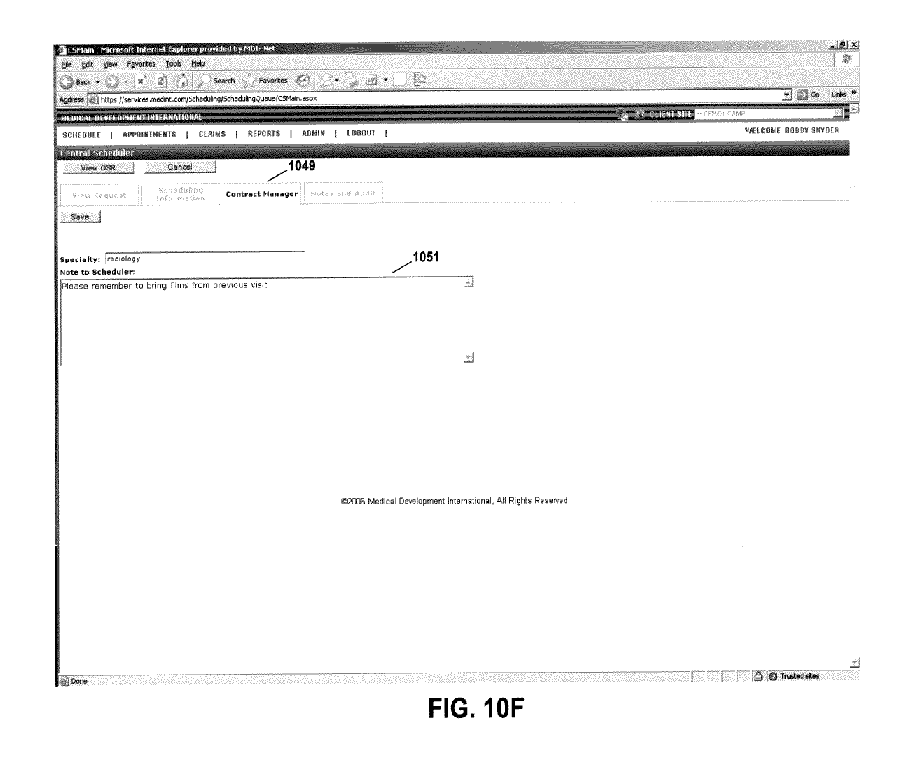

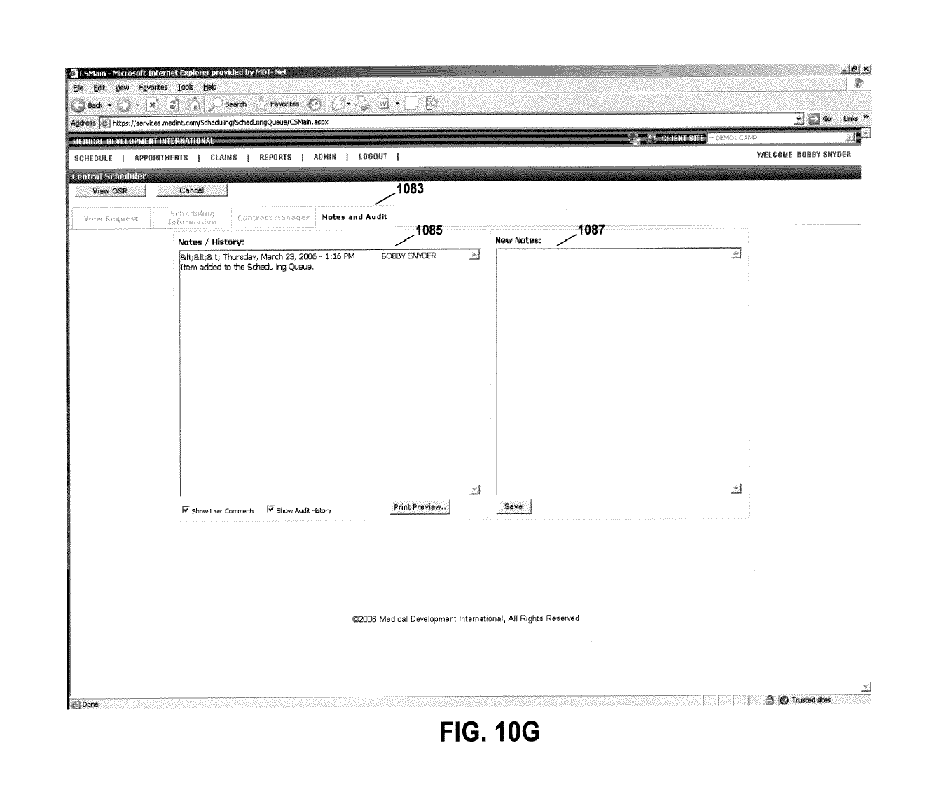

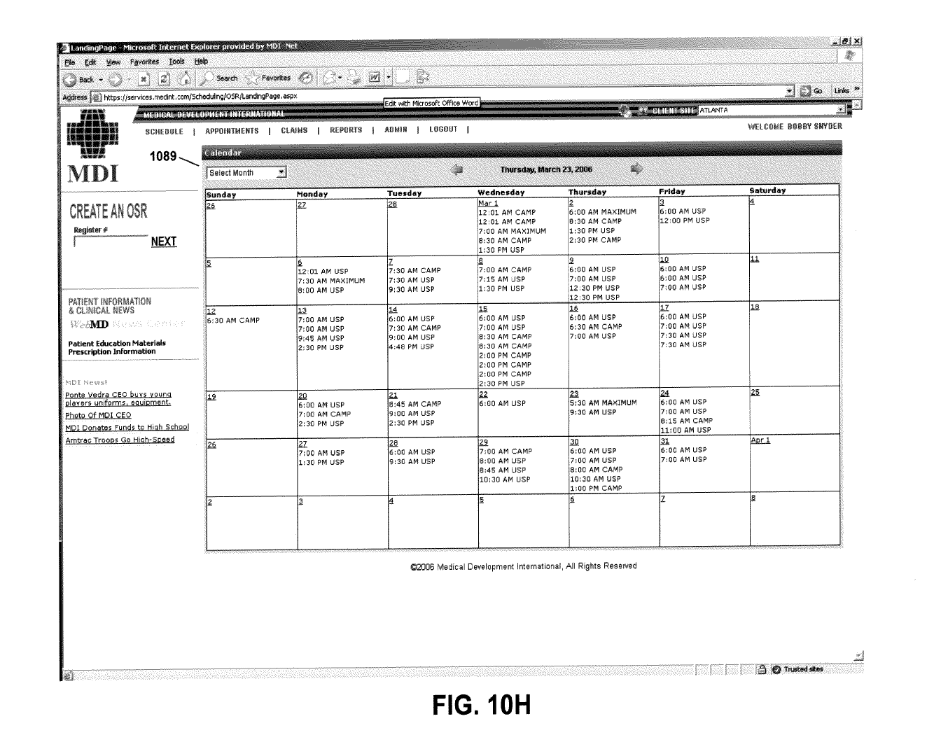

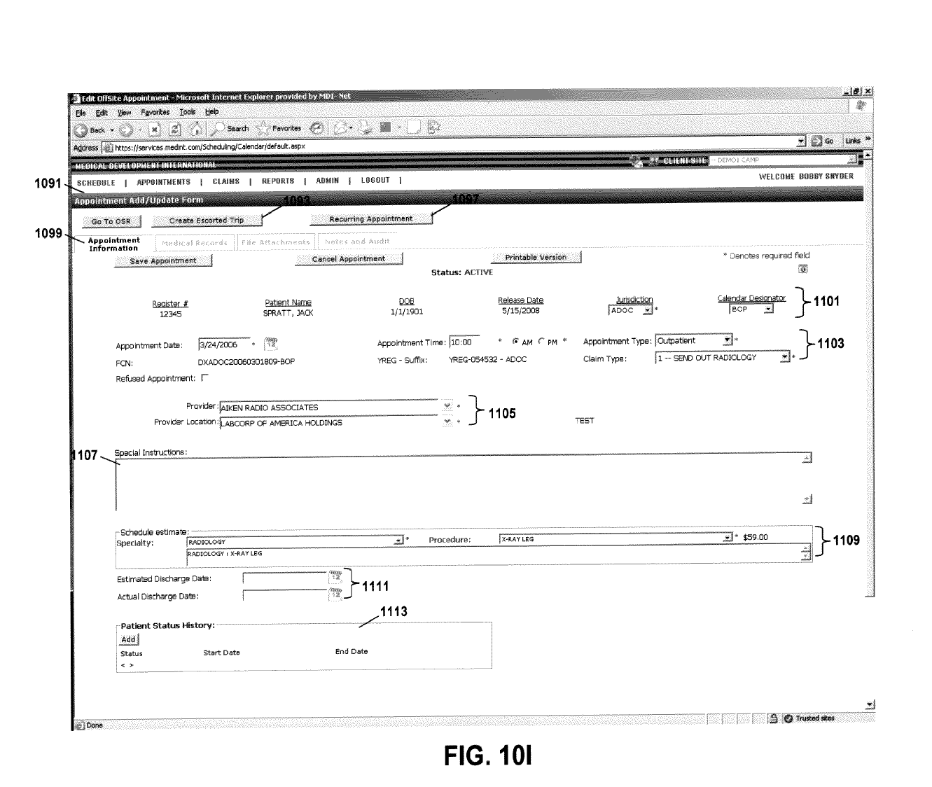

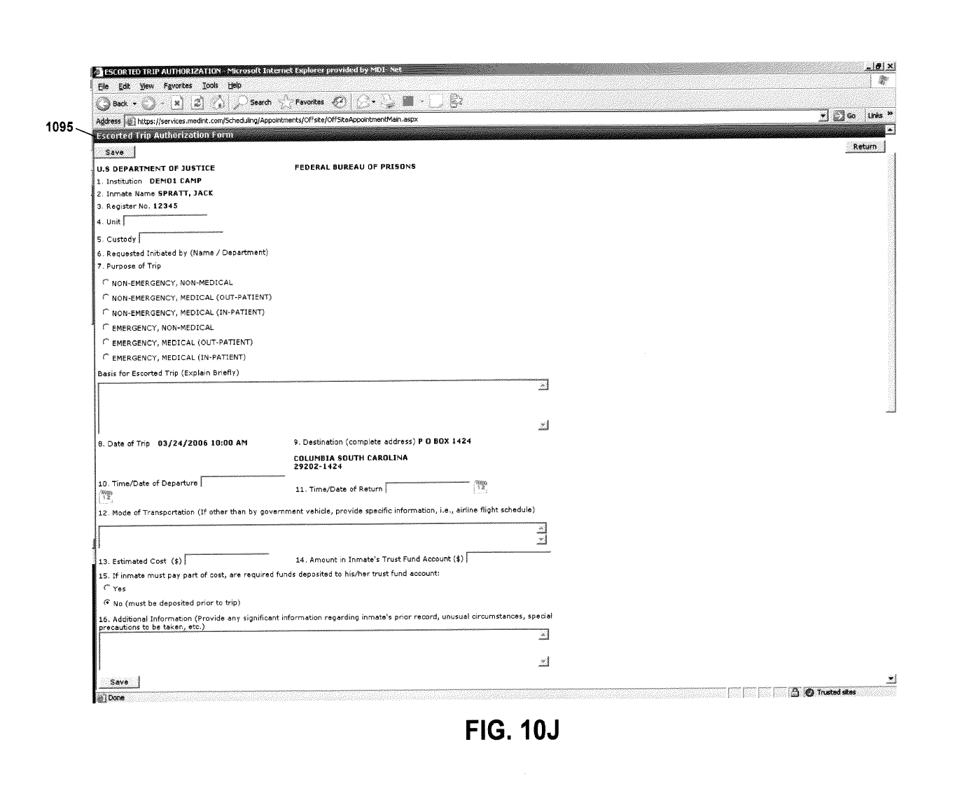

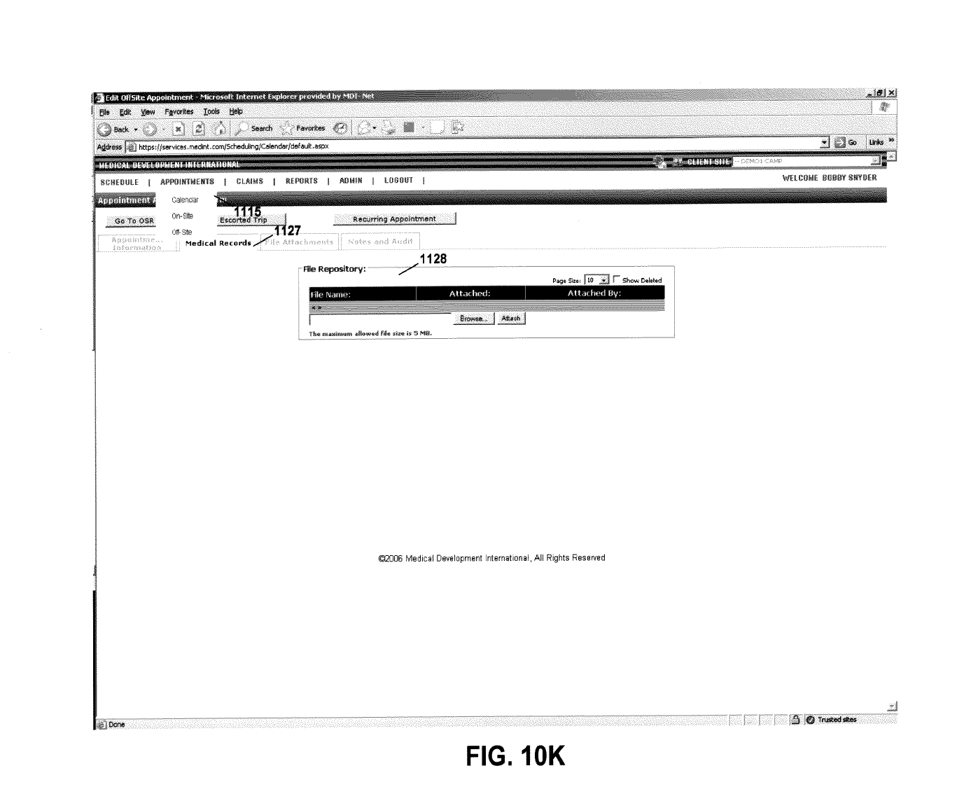

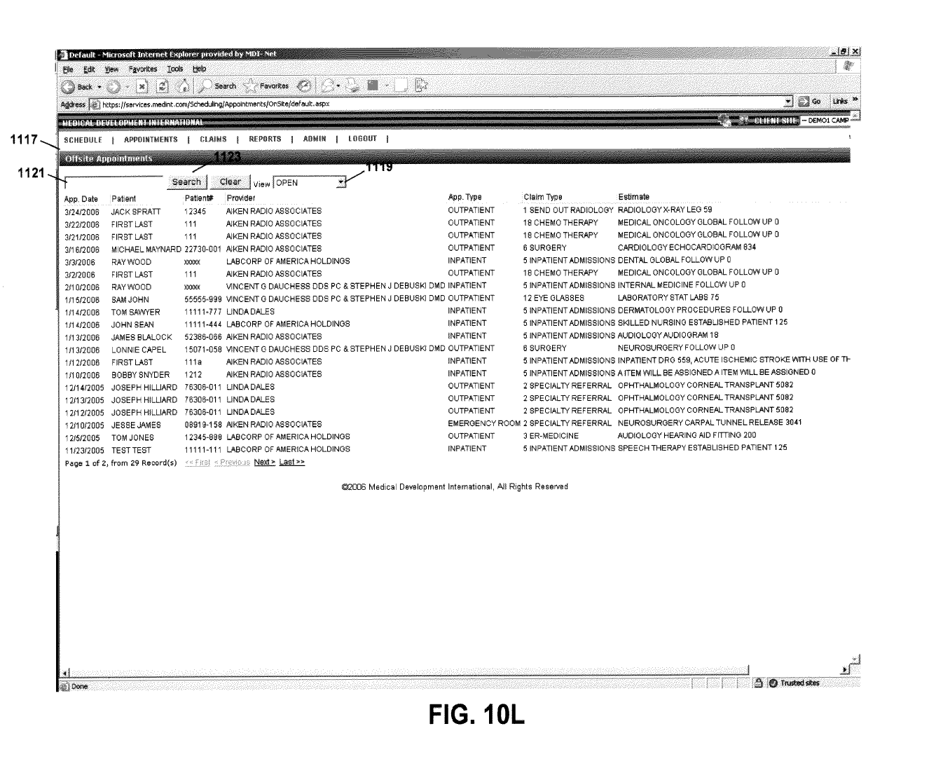

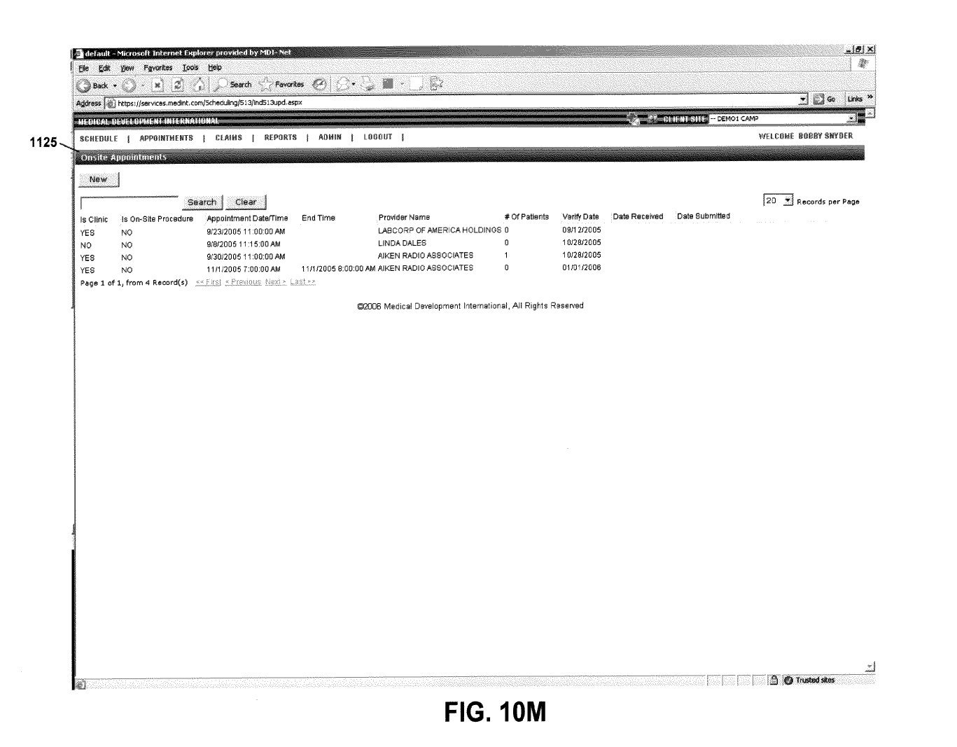

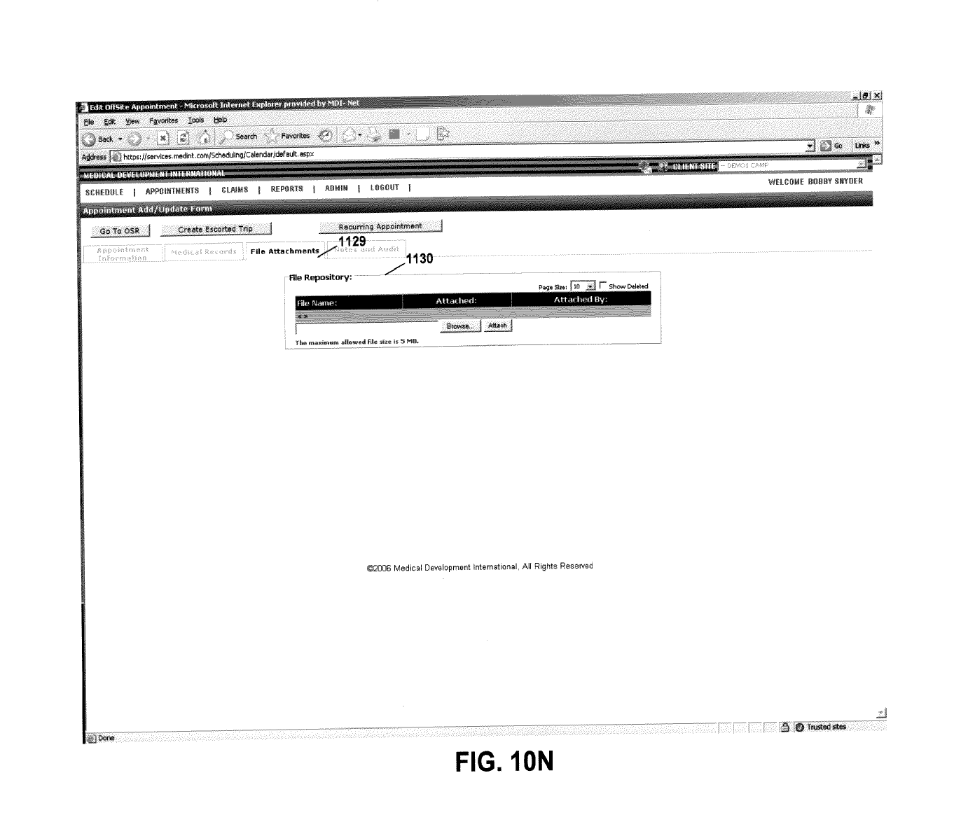

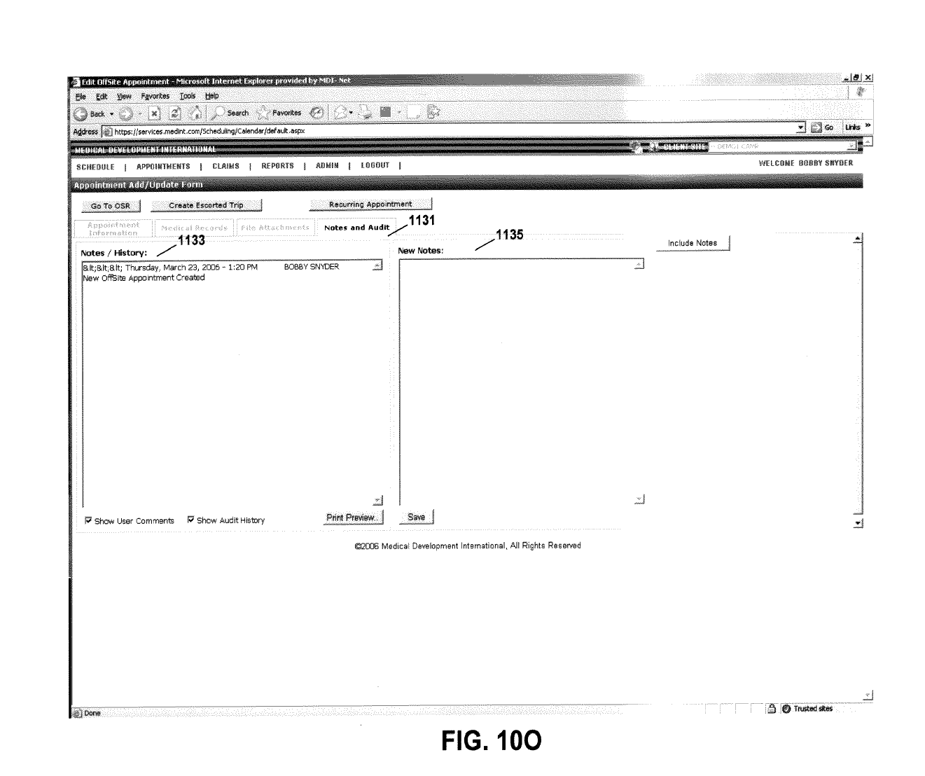

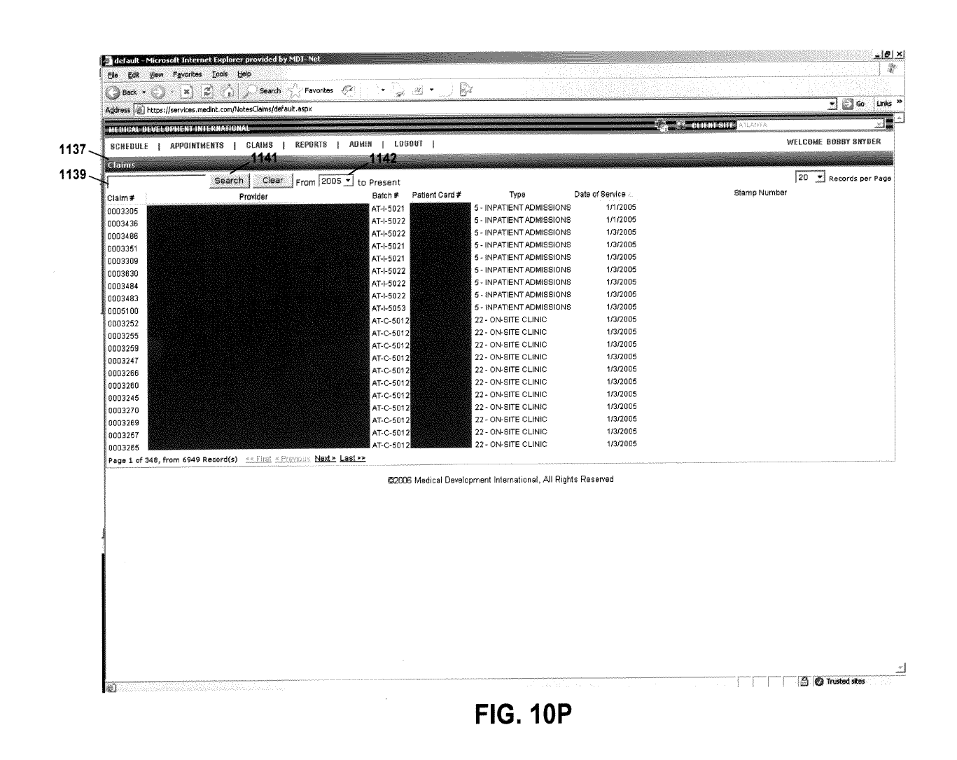

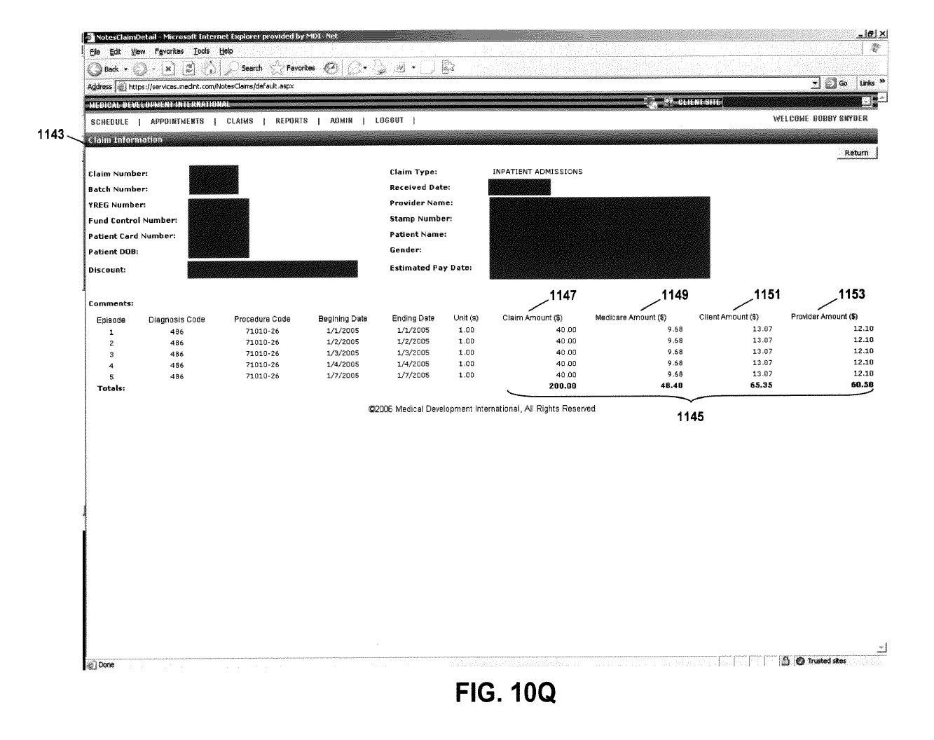

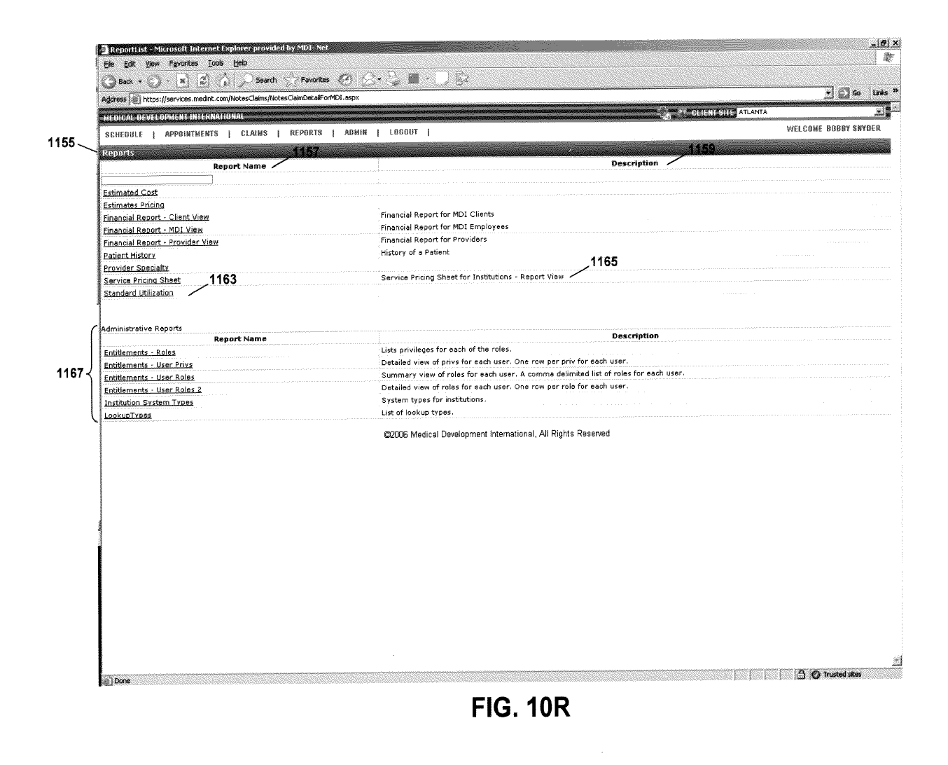

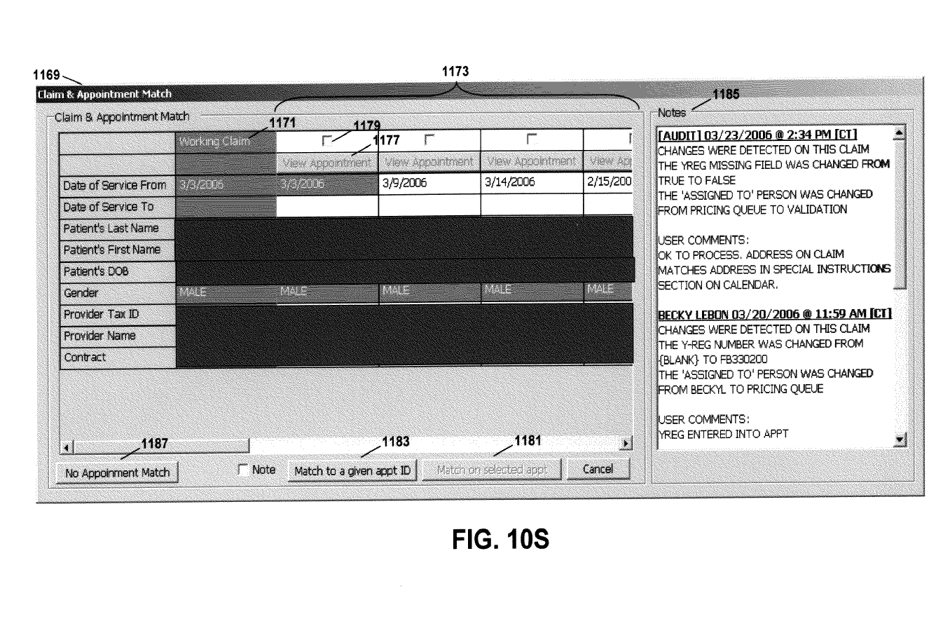

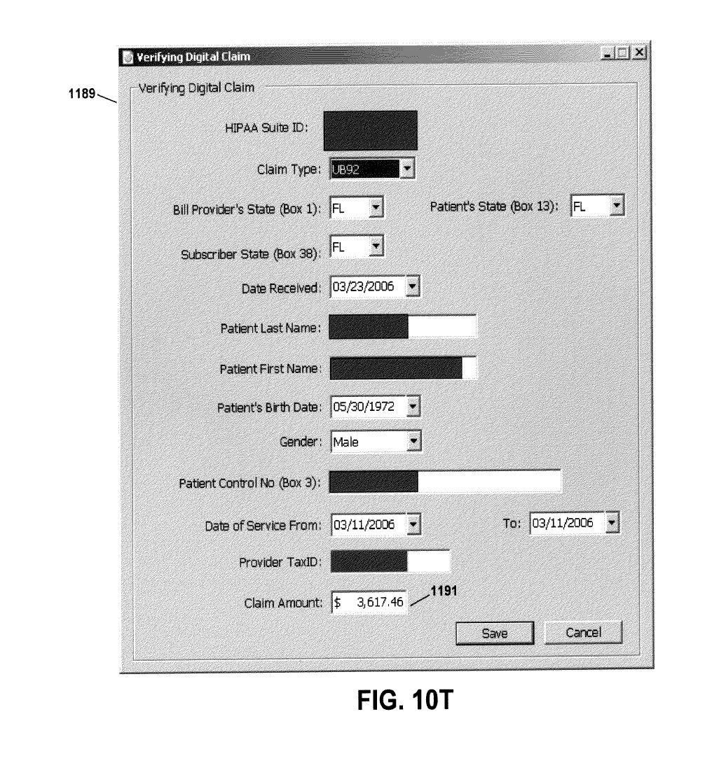

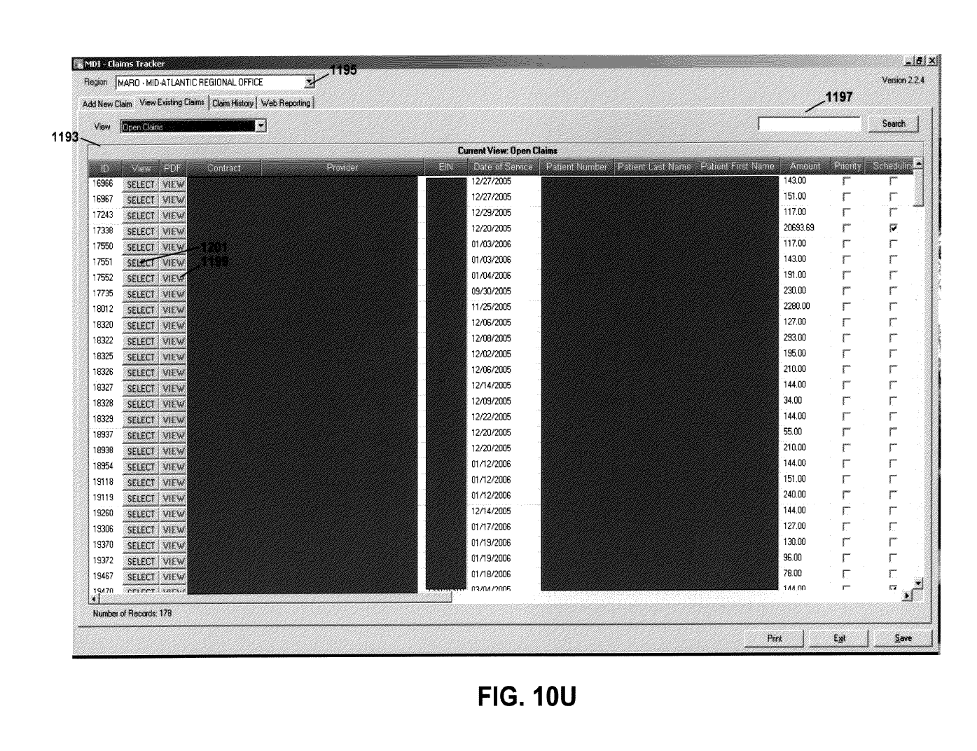

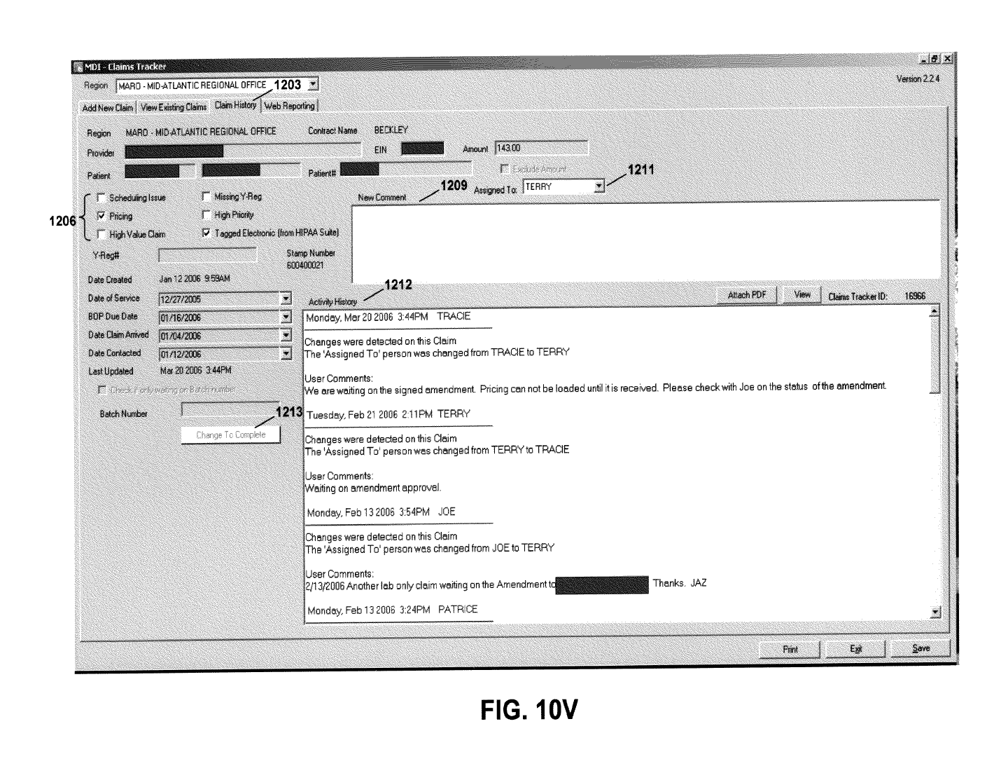

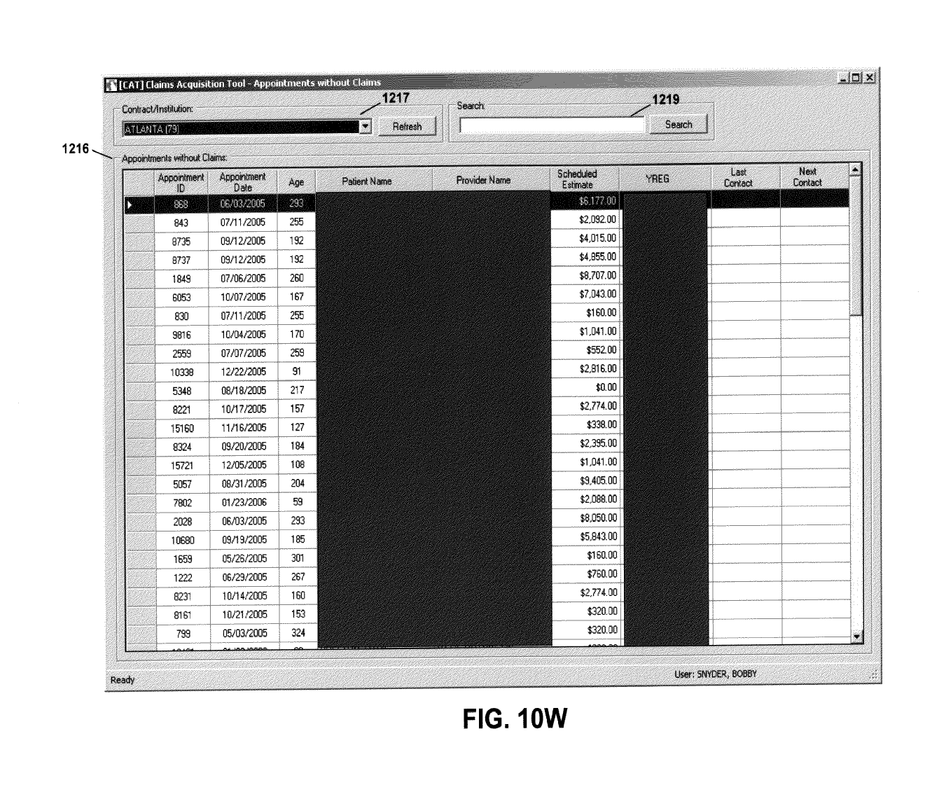

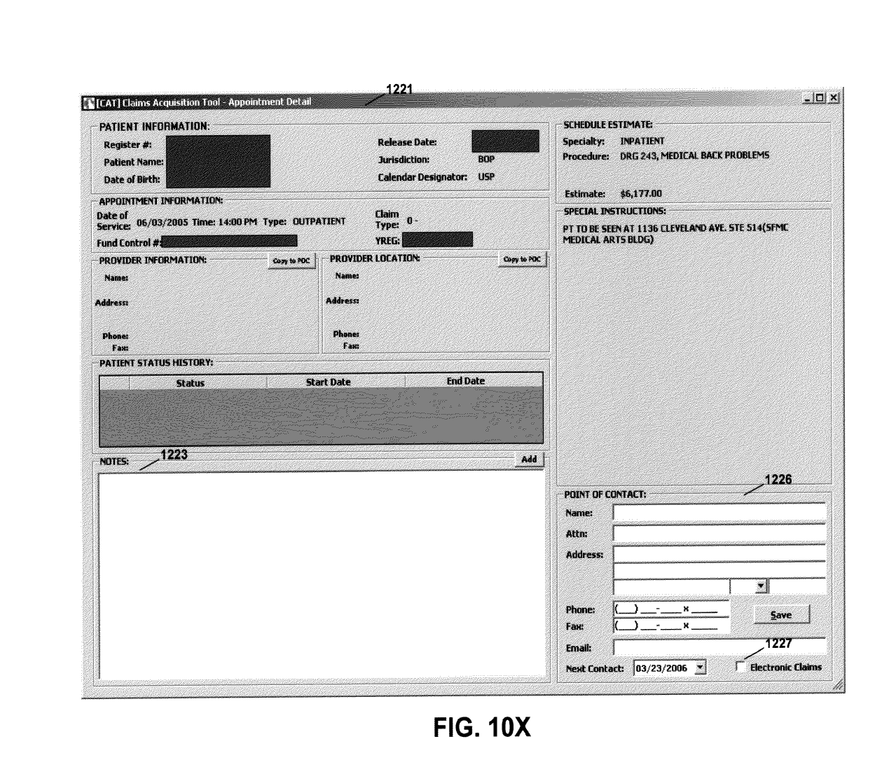

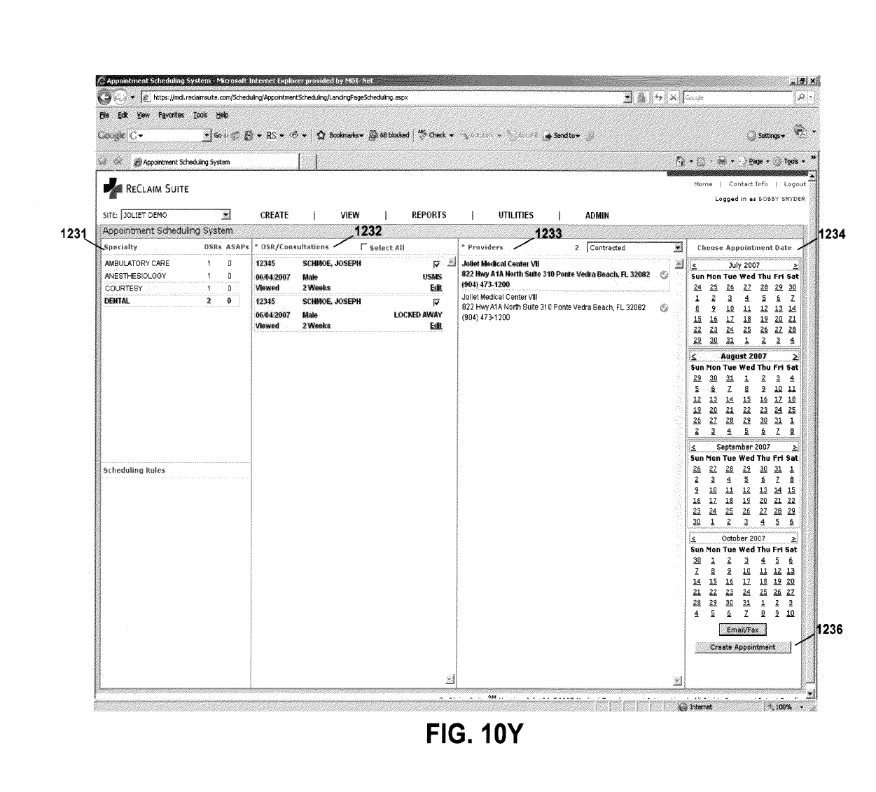

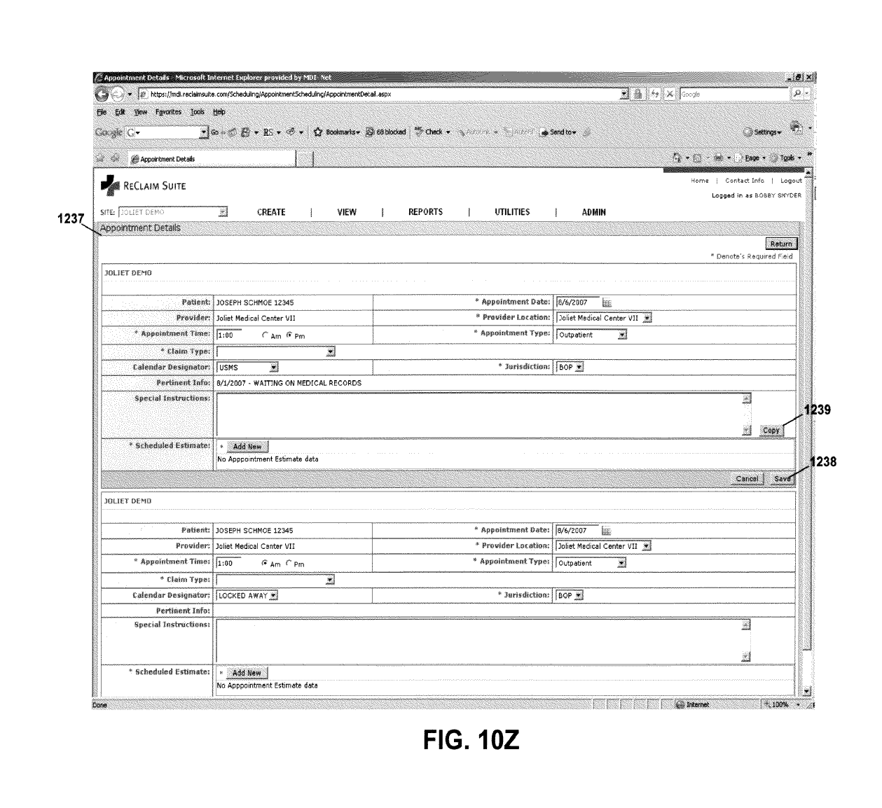

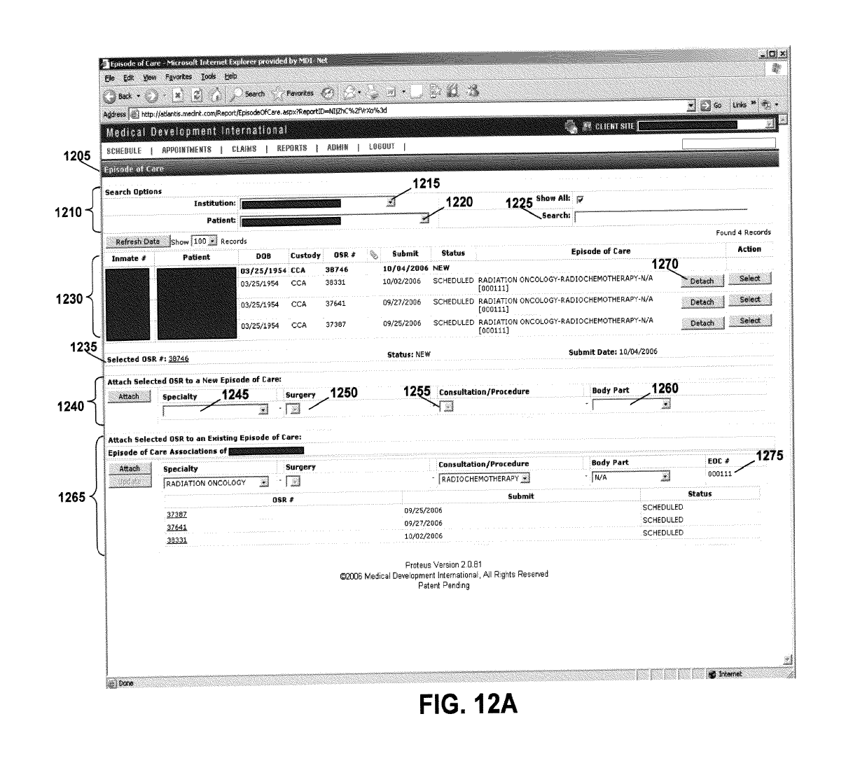

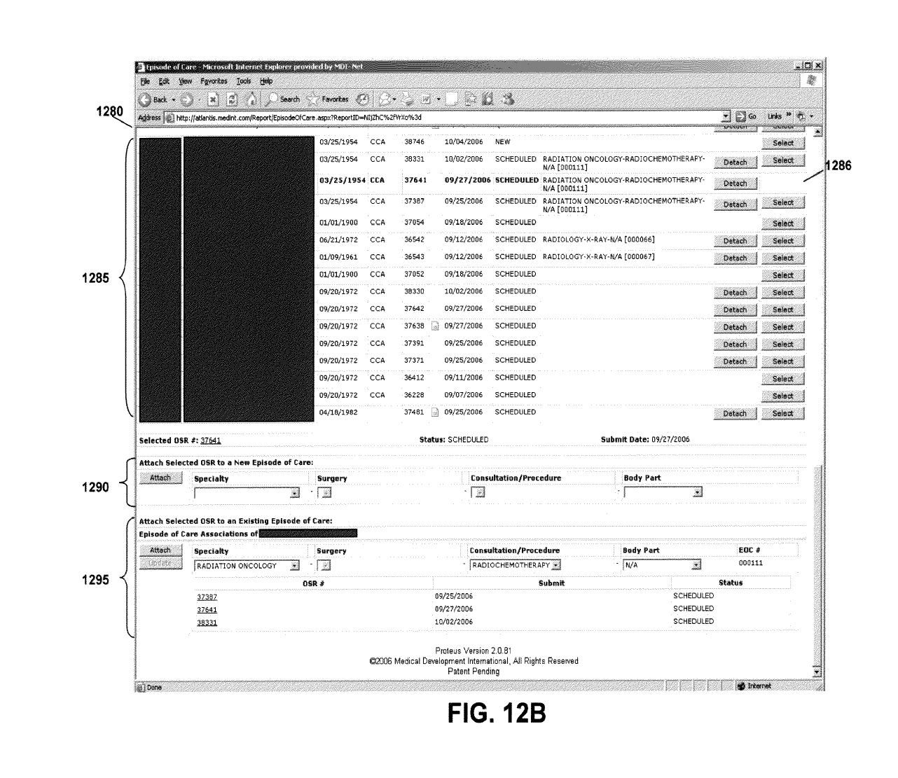

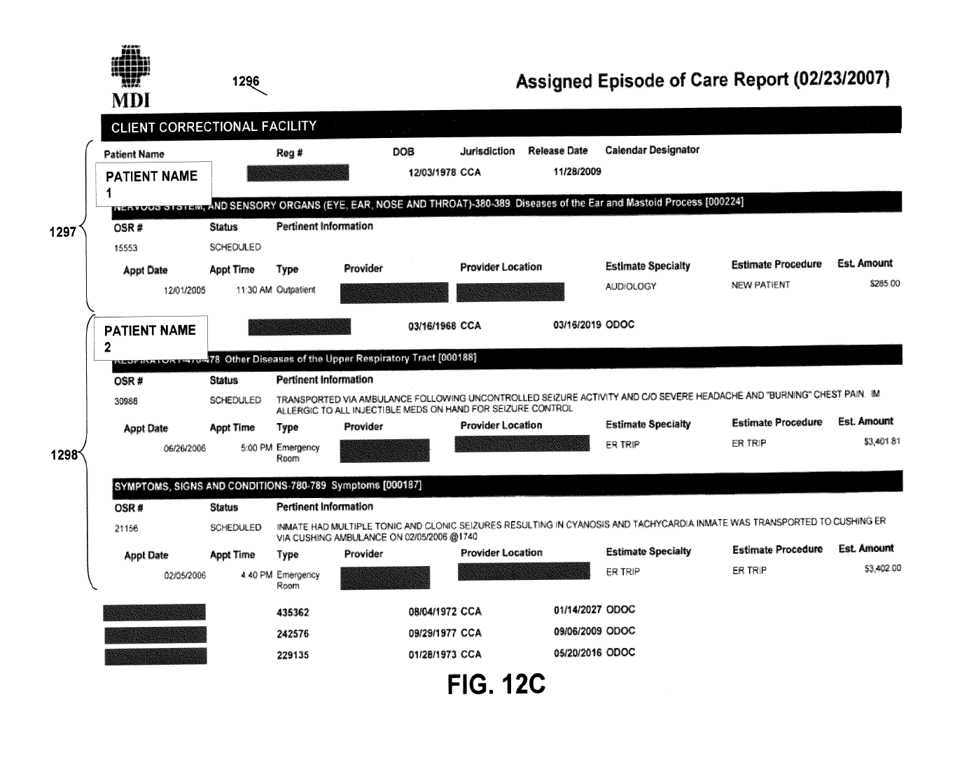

FIGS. 10A-10Z and 12A-12B illustrate an exemplary implementation of the systems and methods described herein for determining the appropriateness of service provider claims for payment and for tracking treatment of patients in the context of providing health care services to inmate patients in a correctional institution. Persons of skill in the relevant art(s) will understand that the systems and methods described herein need not be limited to the application of providing health care services to inmate patients in a correctional institution, and can be applicable to providing health care services in other environments, in which control over patient access to the health care services can be exercised (e.g., school campuses, health maintenance originations (HMOs), military bases, psychiatric institutions, rehabilitation facilities, etc.). PPOs could also benefit by letting members log-on to a scheduling module for “self-referrals” at step 105 of FIG. 1, for instance. Such institutions are referred to herein as “clients” and “client institutions.” Additionally, persons of skill in the relevant art(s) will understand that the systems and methods described herein need not be limited to health care services and providers (e.g., hospitals, doctors, dentists, physicians assistants, therapists, nurse practitioners, etc.), but could possibly be implemented in other service environments, as well.

Web-Based Scheduling Tool

FIGS. 10A-10R and 12A-12B show images of an example web-based scheduling tool that includes a scheduling module, an appointments module, a claims module, a reports module, an episode of care module, and an administrator module. To ensure security, the web-based scheduling tool can be implemented with Secure Sockets Layer (SSL) technology to encrypt information and provide authentication. Persons of skill in the relevant art(s) will understand that the scheduling tool need not be web-based and can be implemented in a secure closed network.

Scheduling Module

When the client institution has a patient in need of medical services, the client can complete a referral request. Using the scheduling module, the client can enter patient information. FIG. 10A shows a Patient Information dialog box 1001, which is a portion of the scheduling module accessible at the client institution. In particular, the client can enter a code identifying the patient. In the example shown in FIG. 10A, the client enters a Register Number 1003, which is a unique number assigned to an inmate that remains associated with the inmate whenever incarcerated. If the patient's code has previously been entered into the scheduling module it can be stored indefinitely and the scheduling module can automatically complete the remaining fields of patient information. Conveniently, the scheduling module can be implemented to poll the client institution to check for information required to complete the fields to save the client time in completing the Patient Information section 1001.

If the patient's code has not been previously entered into the scheduling module, the client can complete the remaining patient information fields shown in FIG. 10A, including name, gender, jurisdiction (i.e., the name of the organization responsible for the patient, such as the Bureau of Prisons (BOP), the U.S. Marshall Service, etc.), calendar designator (i.e., on which calendar the appointment should be displayed, as will be described in more detail below), date of birth, and release date from the correctional institution (i.e., so that the institution does not pay for services rendered after the patient had been released or leaves the institution). Persons of skill in the relevant art(s) will understand that the scheduling module can be implemented with other patient information fields not shown in the example of FIG. 10A. Additionally, as shown in FIG. 10A, patient information fields can be implemented as drop-down menus 1004 listing available options for completing a particular field, and links to a viewable calendar 1005 can be provided for convenient selection of particular dates. Furthermore, in addition to completing the patient information fields, the client can also attach pertinent patient files, such as x-ray films, etc.

Using the scheduling module, the client can then enter patient appointment information. FIG. 10B shows a Patient Appointment Information dialog box 1007, which is another portion of the scheduling module accessible at the client institution. In particular, the client can provide an expenditure authorization code 1009. In the example of FIG. 10B, the client provides a “YREG,” which is an authorization code specific to the BOP. In this case, the client has the option of selecting a checkbox 1011 to have the scheduling module automatically fill in the most recently used YREG. Other clients might provide a purchase order number, etc. instead of a YREG. The client also has the option of entering a client-specific Suffix 1013 to help the client further track the patient (e.g., the suffix might indicate a security level associated with an inmate, a level of billing, or any other client-defined field). The client can also enter an Appointment Time Frame 1014 to indicate a desired time frame for the appointment (e.g., one week, next month, as soon as possible, patient taken to emergency room, etc.). As shown in FIG. 10B, the Appointment Time Frame field 1014 can be implemented as a drop-down menu for faster completion. The client also has the option of entering in the Pertinent Information field 1015 any pertinent information about the patient (e.g., to explain why the patient was submitted to the emergency room or needs to see a particular specialist, or to include other notes, such as the reminder shown in FIG. 10B).

Also shown as part of the Patient Appointment Information dialog box 1007, is a Preliminary Estimate field 1017. Here the client can select a particular Specialty from a drop-down menu 1019 and a corresponding Procedure from a nested drop-down menu of procedures 1021 available for the selected specialty. Based on these selections, the scheduling module can automatically generate a preliminary estimate (e.g., $59.00 is this example) of the cost for the selected specialty/procedure combination that the client can use for planning and/or authorization purposes.

Having entered the pertinent patient and appointment information, the client can forward the referral request to a Central Scheduler of the scheduling module. In the example of FIG. 10B, the client can select the Create OSR link 1023 to forward the off-site referral (to request an appointment with a service provider to see the patient off-site) or on-site referral (to request an appointment with a service provider to see the patient on-site), both referred to herein as OSRs, to the Central Scheduler. The scheduling module can be configured to automatically assign a unique referral identification code to each OSR and generate an electronic OSR that is forwarded to the Central Scheduler.

Using the scheduling module, a scheduler can create an appointment based on the OSR. FIG. 10C shows a View OSR dialog box 1025, which is a portion of the scheduling module accessible at the Central Scheduler through which a scheduler (or other user) can View, Edit, Attach Consult, Schedule Appointment, Create Queue, Print, and Cancel particular OSRs. FIG. 10C shows an example electronic OSR 1027 that includes a contact information field 1029 for the client institution Contract Manager, a contact information field 1031 for the Central Scheduler Primary Contact, and a patient information field 1033 (i.e., Inmate Information in this example) and a Pertinent Information field 1035, which includes information previously entered by the client institution.

By selecting the Attach Consult button 1037, the scheduler/user can attach to an appointment a consultation sheet, such as a Standard Form (SF) 513, which is a form the client institution can complete to communicate the patient's condition directly to the service provider. The scheduling module can store images of attached consultation sheets. In this way, the scheduler/user can not re-write the verbiage of the form, potentially reducing possible liability for treatment error. Optionally, the client institution can use the scheduling module to access and complete an electronic Consultation Sheet 1039, as shown in FIG. 10D, which can then be printed and submitted to the contract manager electronically, by facsimile, by paper mail, or by any other suitable manner of submission.

The Central Scheduler can create a queue of OSRs that have been submitted by the client. A scheduler is then responsible for contacting a service provider in a network of service providers affiliated with the client to schedule an appointment in accordance with each OSR. From the View OSR dialog box 1025 described above, the scheduler can select the Schedule Appointment button 1041 to enter appointment information for a particular OSR. FIG. 10E shows a Scheduling Information dialog box 1043 of the Central Scheduler, through which the scheduler completes various appointment information fields. The client might have scheduling rules that the scheduler should consider when making the appointment with the service provider, which are displayed in the Institution Scheduling Rules field 1045. Any pertinent information that was entered by the client is displayed in the Pertinent Information field 1047. FIG. 10F shows a Contract Manger dialog box 1049 through which the contract manger can communicate notes to the scheduler by completing the Note to Scheduler field 1051. These notes appear in the Scheduler Notes field 1053 of the Scheduling Information dialog box 1043, shown in FIG. 10E. Similarly, the scheduler can communicate any special instructions to the contract manger and others by completing the Special Instructions field 1055, also shown in FIG. 1E.

Among other information shown in FIG. 10E (i.e., Referred By, Requested Appointment Date, and Specialty), the scheduler can complete the Appointment Information fields 1057, such as an Appointment Type 1059 (e.g., Outpatient), Provider 1061, and Provider Location 1063. As shown in FIG. 10E, fields 1059-1063 can be implemented as drop-down menus for faster completion. The scheduler can also indicate whether the provider was contacted by selecting an appropriate Provider Contacted radio button 1065 (i.e., the scheduler might have left a message for the provider). Next the scheduler can complete the applicable Jurisdiction 1067 (e.g., Arkansas Dept. of Corrections (ADOC) in this example) and Calendar Designator 1068, which can be pre-selected based on the Patient Information 1001 entered by the client in FIG. 10A. Like the preliminary estimate calculated as shown in conjunction with the Patient Appointment Information dialog box 1007 in FIG. 10B, a Schedule Estimate 1069 can be automatically calculated for the particular specialty/procedure combination indicated (e.g., $59.00 for Radiology/X-Ray Leg in this example).

Additionally, the scheduler can select a unique Claim Type 1071, which can serve as an additional cross-check against corresponding Medicare codes during claim adjudication. After scheduling the appointment, the scheduler can enter the Appointment Date 1073, Appointment Time 1075, and estimate the Appointment Length 1077 and Appointment End Time 1079, which may be useful information for the client if the patient needs to be escorted to the appointment. Finally, the scheduling module typically is configured to automatically assign a unique Fund Control Number (FCN) 1081 to each appointment, which can serve as an additional cross-check against the corresponding fund authorization code (e.g., YREG code) during claim adjudication.

Advantageously, as shown in the Notes and Audit dialog box 1083 of FIG. 10G, the scheduling module can be configured to maintain a complete audit history of the scheduling process for each appointment. In the example of FIG. 10G, the Notes/History field 1085 indicates when an OSR was added to the Central Scheduler queue. Additionally, a user (i.e., scheduler, contract manager, etc.) can add notes in the New Notes field 1087 regarding a particular appointment that will subsequently appear in the Notes/History field 1085.

FIGS. 10Y and 10Z illustrate another exemplary embodiment of a scheduling system that a scheduler can use to create a scheduled appointments. In this embodiment, as shown in FIG. 10Y, a scheduler can select a specialty (e.g., dental) from a Specialty column 1231 that lists all of the specialties that have OSR's created for them. As shown in FIG. 10Y, one or more OSR's may be displayed in an OSR column 1232 for each specialty listed in the Specialty column 1231. Also, “ASAP's” may be listed in the OSR column 1232, which are OSR's that need high priority and are therefore moved to the top of the list in the OSR column 1232. Next, the scheduler can select a particular OSR(s) from the OSR column 1232. As shown in FIG. 10Y, the scheduler can view the OSR and patient information, as well the scheduling information. Additional data can also be viewed for each OSR in the OSR column 1232. Next, the scheduler can select from a Provider column 1233 a provider that will render the requested services. Only providers that are within the selected specialty will be listed in the Provider column 1233. This list of providers can be filtered (e.g., according to whether the provider has been contracted, not contracted, etc.) After a provider is selected, the scheduler can select an actual date for the appointment using the Calendar column 1234. Once an appointment date is selected, they scheduler can press the Create Appointment button 1236, which will display the Appointment Details window 1237, illustrated in FIG. 10Z.

Using the Appointment Details window 1237, the scheduler can fill in the information fields for the appointment that is shown and then select the Save button 1238 to create and save the scheduled appointment. As shown in FIG. 10Z, the Appointment Details window 1237 can show one or many appointments to be scheduled. Also, the scheduler can copy the appointment information from one appointment to another by selecting the Copy button 1239, thereby speeding up the appointment information entry process.

Appointments Module

After an appointment is scheduled, the appointments module can be configured to display the scheduled appointment on a calendar, which can be accessed by various users depending on established access rights. In an embodiment, when the appointments module displays a scheduled appointment on the calendar, the scheduling module removes the corresponding OSR from the Central Scheduler queue. FIG. 10H shows an exemplary view of a high-level calendar 1089, which displays numerous scheduled appointments. The appointments can be selectable so that a user can view and edit the corresponding appointment information. Calendar views can be customized according to the different types of users so that only information pertinent to a particular user is displayed for that user.

FIG. 10I shows an exemplary Appointment Add/Update Form 1091, through which a user can modify and save, cancel or print the appointment information for a selected appointment. Appointment information can be modified by completing the various fields shown in the Appointment Information dialog box 1099, including patient information fields 1101, appointment information fields 1103, service provider information fields 1105, Special Instructions field 1107 (to modify any special instructions entered via the Special Instructions field 1055 of the Scheduling Information dialog box 1043 of FIG. 10E), Schedule Estimate fields 1109, and discharge information fields 1111 (because the client institution should not pay for services rendered after the patient is discharged from the institution). Additionally, the user can add patient status history information via the Patient Status History field 1113. For example, if the patient goes the hospital, it might be useful to track when the patient's status changes from “emergency room” to “in-patient,” etc.

For some clients, such as the BOP, the patient might need to be escorted by a guard or other security personnel to the scheduled appointment. In this case, the client can access the appointments module to download and complete an escorted trip form. Typically, these forms are printed and circulated for signatures at the client institution. As shown in FIG. 10I, the client can select the Create Escorted Trip button 1093 to download and complete an escorted trip form. An exemplary escorted trip form 1095 is shown in FIG. 10J. Also, for some requested procedures, such as dialysis, multiple appointments with the service providers might be required. Thus, as shown in FIG. 10I, a user can select the Recurring Appointment button 1097 to schedule all appointments associated with a particular OSR. These appointments would optimally be displayed in the same manner as other scheduled appointments as described below.

In addition to using the appointments module to view scheduled appointments on the calendar, a user can use the appointments module to filter and sort the scheduled appointments. For example, as shown in FIG. 10K, a user can choose from an Appointments drop-down list 1115 to view the calendar, On-Site scheduled appointments, or Off-Site scheduled appointments. FIG. 10L shows an example listing 1117 of Offsite Appointments. Using the drop-down menu 1119, a user can choose to view open appointments (shown in this example), active appointments, re-scheduled appointments, canceled appointments, etc. Additionally, the user can enter a search term in the search field 1121 and select the Search button 1123 to search all appointments for particular appointment information, such as for a particular provider. A user can also sort all appointments by selecting a particular column of appointment information. For example, the user may sort the appointments according to Appointment Date. FIG. 10M shows an example listing 1125 of Onsite Appointments, which can be filtered, searched, and sorted in a manner similar to that described above for the Offsite Appointments listing 1117 shown in FIG. 10L.

The appointments module can also be configured to enable the scheduler/user to attach a patient's medical record to an appointment. As shown in FIG. 10K, the scheduler can select the Medical Records tab 1127 and browse a file repository 1128 for and attach a patient's medical records. In addition to medical records, the scheduler/user can attach other files relating to a particular appointment (e.g., x-ray films). As shown in FIG. 10N, the scheduler/user can select the File Attachments tab 1129 and browse the file repository 1130 for and attach other related files.

Like the scheduling module described above, the appointments module can advantageously maintain a complete audit history of the appointment creation process for each appointment. As shown in the Notes/History field 1133 of the Notes and Audit dialog box 1131 of FIG. 10O, the audit history can reflect when a new appointment is created. The audit history can also reflect when an appointment is modified, canceled, the patient is a no-show, etc. Additionally, a user (i.e., scheduler, contract manager, etc.) can add notes in the New Notes field 1135 regarding a particular appointment to subsequently be displayed in the Notes/History field 1133.

Claim Intake Module

Claims from service providers relating to scheduled appointments are received and processed to capture claim information. As described above with respect to FIGS. 1-8, service information from non-electronic claims can be manually captured, while service information from electronic claims can be automatically captured. In the case of manual entry, the double-blind entry process described above can be implemented to detect and correct keying errors. In both cases, an image of the received claim can be generated and attached to each claim record. Discrepancies are then identified and resolved, usually by a third person, particularly when the discrepancy is not automatically resolvable through spell-checker or grammar-checker software components. Advantageously, when used in conjunction with the windows-based adjudication tool, which is described in detail below, to link captured service information with corresponding appointment information, the claims module can provide a user with significantly more information than conventional disparate appointment scheduling and claim processing applications.

Users, such as the client institution, service providers, and schedulers, can use the claims module to filter and sort processed claims and select particular claims to view corresponding service information. For example, FIG. 10P illustrates a Claims dialog box 1137, in which processed claims are displayed. Using a drop-down menu 1142, processed claims from a particular year to present can be displayed. Corresponding service information, such as Claim Number, Provider and Date of Service, etc., can be organized in columns (note that some of the data has been redacted). The user can enter a search term in the search field 1139 and select the Search button 1141 to search all claims for particular service information, such as a particular service provider. A user can also sort all claims by selecting a particular column of service information. For example, the user may sort the claims according to Date of Service.

A user can select a particular claim to view detailed service information for the selected claim. For example, FIG. 10Q shows a Claim Information dialog box 1143 that includes captured service information (note that some of the data has been redacted) for a selected claim. The claims module can be configured to selectively display claim amount information 1145 based on the user. For example, if the user is the scheduler, the scheduler should be able to view all of the claim amount information, including Claim Amount 1147 (i.e., the amount submitted by the service provider), the Medicare Amount 1149 (i.e., the amount Medicare would cover for the claimed procedure), the Client Amount 1151 (i.e., the amount the client institution pays), and the Provider amount 1153 (i.e., the amount paid to the service provider). A service provider should be able use the claims module to view and sort claims that the service provider has submitted but should not be able to view the Client Amount 1151. Likewise, a client institution should be able to use the claims module to view claims associated with its patients but should not be able to view the Provider Amount 1153.

Reports Module

The reports module can be used to generate predefined proprietary or ad hoc reports based on individual or aggregated service information captured from processed claims. FIG. 10R shows a Reports dialog box 1155 that identifies by Report Name 1157 and Description 1159 various reports that can be generated. For example, proprietary reports associated with particular client institutions can be generated to provide such information as the number of OSRs generated, the number of appointments scheduled, canceled, re-scheduled, etc., and aggregated financial information such as the total claim amount, the total savings, and the percentage of savings. The Standard Utilization report 1163 is an example report that allows a user to add filters and sort on any of the information captured by the web-based scheduling tool. For example, the client institution might generate a report for all of the scheduled pathology appointments, showing aggregated financial information, such as the total pathology claim amounts, the pathology claim histories, etc.

The reports module can also be used to access a Service Pricing Sheet 1165 for a particular client institution. For example, by viewing the Service Pricing Sheet 1165, the client institution can quickly review the pricing structures of their provider networks. The reports module can also be used to generate various Administrative reports 1167, as shown in FIG. 10R, which can be used to identify user roles and privileges with respect to the web-based scheduling tool.

The web-based scheduling tool further includes an administrator module that an administrator can use to define user roles and access privileges associated with the various modules, as well as to define and modify the provider networks and corresponding service providers.

Episode of Care Module

In one implementation, the web-based scheduling tool can include an episode of care module to enable a user, such as the client, scheduler, and/or service provider, to track treatment of a patient by establishing an “episode of care” for the patient. The episode of care pertains to the treatment of a specified ailment from start-to-finish. In this way, the user can associate with an established episode of care OSRs, scheduled appointments, and/or claims for the patient that correspond to the treatment of the specified ailment. Establishing episodes of care can be beneficial in enabling the client to determine how much a particular patient is costing the client for healthcare. Tracking patient healthcare costs can be advantageous when the client is only responsible for paying patient healthcare costs up to a particular dollar amount. Additionally, grouping OSRs, appointments, and/or claims into episodes of care for treatment of specified ailments can also be beneficial in assessing the financial impact of particular health problems.

FIG. 12A shows an Episode of Care dialog box 1205 configured to enable a user to establish for a patient an episode of care pertaining to treatment of a specified ailment. The Episode of Care dialog box 1205 includes a Search Options field 1210 having an Institution drop-down list 1215 and a nested Patient drop-down list 1220 that can be used to search for a particular client institution and patient. Also, a Search field 1225 can be used for key word searching of a particular client institution and/or patient. The retrieved records 1230 can be displayed showing Inmate #, Patient, DOB, Custody, OSR #, Submit, Status and Episode of Care data fields (note that some of the data has been redacted).

In the example shown in FIG. 12A, the user has selected an OSR 1235, which has a status of “NEW.” Using an Attach Selected OSR to a New Episode of Care field 1240, the user can establish a new episode of care and associate the selected OSR 1235 with the newly established episode of care. In establishing the new episode of care, Specialty 1245, Surgery 1250, Consultation/Procedure 1255, and Body Part 1260 drop-down lists can be used to describe the treatment and ailment associated with the new episode of care.

The user can also associate the selected OSR 1235 with an existing episode of care using an Attach Selected OSR to an Existing Episode of Care field 1265. While only one existing episode of care is shown for the patient identified in the example illustrated in FIG. 12A, the Existing Episode of Care field 1265 can identify multiple/all episodes of care associated with the identified patient. Additionally, the user can edit the Specialty, Surgery, Consultation/Procedure, or Body Part corresponding to an existing episode of care. Detach buttons 1270 can be used to edit an existing episode of care by detaching an associated OSR. In one implementation, the episode of care module can be configured to assign a unique identifier to each established episode of care. In the example shown in FIG. 12A, an EOC # field 1275 indicates that a numerical identifier “000111” has been assigned to the existing episode of care “Radiation Oncology-Radiochemotherapy” for the identified patient.

FIG. 12B shows an Episode of Care dialog box 1280 displaying all of the OSRs for a particular client institution. Like the Episode of Care dialog box 1205, shown in FIG. 12A, Episode of Care dialog box 1280 can display retrieved records 1285 showing Inmate #, Patient, DOB, Custody, OSR #, Submit, Status and Episode of Care data fields (note that some of the data has been redacted). Also, the Episode of Care dialog box 1280 includes an Attach Selected OSR to a New Episode of Care field 1290 that can be used to establish a new episode of care and associate a selected OSR 1286 with the newly established episode of care, and an Attach Selected OSR to an Existing Episode of Care field 1295 that can be used to associate the selected OSR 1286 with an existing episode of care. Further, using the Episode of Care dialog box 1280, the user can detach OSRs and edit the ailment and treatment information associated with an existing episode of care.

Optionally, the episode of care module can be used to generate an episode of care report. The episode of care report can enable clients to view appointments and claims that are associated with each OSR of an episode of care, as well as monetary amounts for each episode of care and each claim. In this way, the episode of care report can enable a client to make assessments regarding a particular episode of care for a patient. For example, FIG. 12C shows an exemplary episode of care report 1296 for a particular client correctional facility. In this example, the episode of care report 1296 includes a field 1297 pertaining to an episode of care for a first patient and field 1298 pertaining to an episode of care for a second patient. As shown in FIG. 12C, the patient episode of care fields 1296 and 1297 can display appointment and claim information for each OSR of the corresponding episodes of care (note that some of the data has been redacted), in addition to the associated monetary costs. The episode of care report can be configured to display episode of care information in various formats and need not be limited to the report format illustrated in FIG. 12C.

Persons of skill in the relevant art(s) will understand that the episode of care module need not be configured as shown in the exemplary implementations depicted in FIGS. 12A-12C. For example, instead of selecting OSRs, the episode of care module can be configured to enable the user to associate scheduled appointments and/or processed claims to a new or existing episode of care. In this way, one user might initially associate an OSR or appointment with an episode of care, while another user might associate a claim with the episode of care or associate the OSR, appointment, and/or claim with a different, previously established, episode of care. The web-based scheduling tool can be implemented so that the episode of care module is accessible via the claims or reports modules or as a stand-alone module.

Windows-Based Adjudication Tool

As described above, the web-based scheduling tool can be configured to track information throughout the entire appointment process, from the referral request, to a scheduled appointment, to a processed claim. The windows-based adjudication tool, which is described in detail below, can advantageously be configured to use the tracked information to determine the appropriateness of claims received from service providers. FIGS. 10S-10V show images of an example windows-based adjudication tool that includes an adjudication module and a claim tracker module.

Persons of skill in the relevant art(s) will understand that the adjudication tool need not be windows-based and can instead be implemented as a secure web-based application.

Adjudication Module

Conventional claims processing systems typically provide little protection against fraudulent and erroneous claims. To reduce the number of fraudulent and erroneous claims being paid, in one embodiment, the adjudication module can advantageously determine the appropriateness of the received claims by only submitting for payment received claims that can be matched to scheduled appointments. However, in another embodiment, all claims need not be matched to scheduled appointments in order to be processed. Unlike conventional disparate appointment and claim processing systems and methods, the integrated scheduling and adjudication tools described herein can be configured to quickly and accurately determine the appropriateness of the received claims.

The adjudication module can queue received claims in an adjudication queue and intelligently serve up unverified claims from the queue to available adjudicators for validation. An adjudicator can initiate a search for candidate appointments that match a particular received claim. The adjudication module can use logic, fuzzy logic and/or AI to compare the service information associated with the particular received claim to the appointment information associated with each of the scheduled appointments, and can weight each scheduled appointment based on a degree of similarity to the particular received claim. The adjudication module can also perform a duplicate check before or after the appointment match to determine whether the particular received claim is a duplicate of an already processed claim and to identify services of the particular received claim that are duplicate services (i.e., multiple claims might be received for one appointment and the same service might be identified in more than one of the claims). The adjudication process is described in more detail above in conjunction with FIGS. 1-8.

FIG. 10S shows an exemplary Claim & Appointment Match dialog box 1169 of the adjudication module in which a particular received claim can be identified in the Working Claim field 1171 and several candidate appointments 1173 can be displayed according to degree of similarity next to the working claim, with the best match occupying the first position adjacent to the working claim, and so forth. The accuracy of the adjudication module can be such that most of the time the correct appointment is placed in the first position adjacent to the working claim.

In the event that the adjudication module determines that an appointment perfectly matches the working claim, the adjudication module can be configured to display the perfectly matching candidate appointment differently, for instance by highlighting the perfectly matching candidate appointment in a particular color. The adjudicator can manually validate the working claim by selecting a View Appointment button 1177 to view the appointment information corresponding to the candidate appointments and determine which one of the candidate appointments, if any, matches the working claim. The adjudication module can alternatively be configured to automatically validate claims for which a perfectly matching candidate appointment is identified so that the adjudicator need only manually validate those claims for which no perfectly matching appointments are identified.

As further shown in FIG. 10S, after the adjudicator identifies a candidate appointment that matches the working claim, the adjudicator can select the candidate appointment using the appropriate checkbox 1179 and the Match On Selected Appointment button 1181. If the adjudicator determines that an appointment having a particular unique appointment identifier code matches the working claim, the adjudicator can select the Match To A Given Appointment ID button 1183 to digitally tie the unique claim identifier code of the working claim to the unique appointment identifier code of the matching appointment. If the adjudicator determines that none of the candidate appointments matches the working claim, the adjudicator can add a note defining the problem in the Notes field 1185 and select the No Appointment Match button 1187. In this case, the working claim can be “flagged” (i.e., identified in some fashion) as a problem claim and forwarded to the claim tracker module for resolution as described below.

FIG. 10T shows an example Verifying Digital Claim dialog box 1189 (note that some of the data has been redacted), which can be used to verify the service information associated with a particular claim, such as the Claim Amount 1191. Note that this verification step can be bypassed or omitted. The adjudication process ends when the adjudicator verifies the working claim and submits it for payment.

Claim Tracker Module

The windows-based adjudication tool can advantageously be configured to include a claim tracker module that intelligently routes a flagged claim to various trouble shooters in an attempt to resolve the problem in a timely manner (e.g., typically in as little as a few days for the claim tracker module, as opposed to a few months for conventional claim processing systems and methods). The trouble shooters can be grouped according to geographic regions and attempt to resolve the problems associated with the flagged claims in a queue of flagged claims for their particular region. For example, FIG. 10U shows an exemplary queue of open flagged claims 1193 for a particular region. A particular region can be selected using the drop-down menu 1195. In this case, the flagged claims for a Mid-Atlantic Regional Office (MARO) are displayed (note that some of the service information has been redacted).

The claim tracker module can also be configured to generate customized views based on the user. For example, the claim tracker module can be configured to only display the flagged claims forwarded to a particular adjudicator or contract manager, and not display all of the flagged claims to each user. As shown in FIG. 10U, the user can execute customized searches for flagged claims (e.g., flagged claims having a particular problem) using the search field 1197, and reorder the display of the flagged claims by sorting the flagged claims according to the various column categories (i.e., ID, Contract, Provider, EIN, Date of Service, Patient Number, Patient Last/First Name, Amount, etc.). The user can also select a particular View button 1199 to view a PDF file of a claim image and a particular Select button 1201 to select a particular flagged claim and take steps to resolve the identified problem.

FIG. 10V shows a Claim History dialog box 1203 of the claim tracker module for an exemplary flagged claim (note that some data has been redacted). The Claim History dialog box 1203 can display relevant appointment and service information associated with the flagged claim, including an indication of the particular problem 1206 (e.g., Pricing in this example). Each user can view an Activity History field 1212, which can indicate to whom the flagged claim has been routed, when it was routed, and what each user has done to try to resolve the problem. Each user that works on resolving the flagged claim can enter a comment in the New Comment field 1209 and assign the flagged claim to another user for further resolution by selecting a user from the Assigned To drop-down list 1211. In this way, the claim tracker module might motivate the users to work to resolve the flagged claims in a timely fashion, or at least might be used to identify where particular flagged claims are stymied.

For example, if the problem is no appointment was scheduled for the flagged claim (e.g., the patient had to go to the emergency room and the client institution did not have time to complete a referral request), then the trouble shooter might attempt to determine which client institution is associated with the flagged claim, and forward the flagged claim to the contract manager requesting that the contract manager complete a referral request so that an appointment can be created. In another example, if the problem is a pricing error (e.g., an appointment corresponds to the claim but the adjudicator could not find a contract with the service provider, who submitted the claim), the trouble shooter might forward the claim to the contract manager to work out the pricing problem. In other cases, the trouble shooter might forward the claim to the service provider, for example, if there is a Medicare problem (e.g., an incorrect Medicare code for the claimed service).

The claim tracker module can be configured with a reporting feature to periodically produce reports that monitor the progress of the different regions (e.g., the report can identify flagged claims for which no activity has occurred for several days, what flagged claims are being resolved by contract mangers, an average length of time the flagged claims have been in the claim tracker module, etc.). Such reports can be beneficial for expediting the time it takes to resolve the flagged claims so that service providers can get paid in a more timely fashion. A trouble shooter can indicate when the problem associated with a particular flagged claim is resolved by selecting the Change to Complete button 1213. In one embodiment, the claim tracker module can be configured to route the resolved flagged claim to the top of the adjudication queue so that it is validated by an adjudicator in an expedited fashion. Additionally, the claim tracker module can be configured to remove the claim from the flagged claim queue only after the adjudicator submits the resolved flagged claim for payment.

Claims Acquisition Tool

In addition to the scheduling and adjudication tools described above, a claims acquisition tool can be configured to identify appointments that have not been associated with particular received claims by the adjudication module. By identifying and resolving such appointments, the claims acquisition tool can recover claims for the service providers, making it more advantageous for the service provider to contract with the client institution.

Based on the appointment information, the claims acquisition tool can be configured to determine what type of claim is anticipated for a particular appointment. In this way, if no claim is received within a predetermined time period after the appointment is to have occurred, a trouble shooter can contact the service provider with whom the appointment was scheduled and determine whether the service provider has already submitted or is going to submit a corresponding claim. The claims acquisition tool can also be configured to analyze the appointment information and determine how many claims are anticipated to be received for a particular appointment (i.e., for some appointments, multiple claims from one or more service providers might be anticipated due to various procedures being performed at the appointment). In this way, if the anticipated number of claims is not received within a predetermined time period after the appointment is to have occurred, a trouble shooter can contact the service provider(s) with whom the appointment was scheduled and determine whether the service provider has already submitted or is going to submit an anticipated claim.

Like the claim tracker module described above, the claims acquisition tool can be configured to maintain a working list of appointments for which claims are expected. After the adjudication module associates a particular received claim with an appointment in the claims acquisition tool list, the appointment can be removed from the list. FIGS. 10W and 10X show images of an example windows-based claims acquisition tool. Persons of skill the relevant art(s) will understand that the claims acquisition tool need not be limited to a windows-based implementation, and can also be implemented in a web-based environment. FIG. 10W shows an exemplary list of Appointments without claims 1216 for a particular Contract/Institution that can be selected from a drop-down menu 1217 (note that some of the data has been redacted). A trouble shooter can execute customized searches for particular types of appointments using the search field 1219 and reorder the display of the appointments by sorting the appointments according to the various column categories (i.e., Appointment ID, Appointment Date, Age, Patient Name, Provider Name, Scheduled Estimate, YREG, Last Contact, Next Contact, etc.). The trouble shooter can also select a particular appointment and view the associated appointment information.

FIG. 10X shows an Appointment Detail dialog box 1221 for an exemplary appointment without a claim that includes the associated appointment information. Via the Appointment Detail dialog box 1221, the trouble shooter can add notes (e.g., to request information) by completing a Notes field 1223, and save new points of contact by completing a Point of Contact field 1226 (e.g., when the original point of contact for a provider is no longer valid and the new point of contact needs to be notified that a claim should be submitted for the appointment). The trouble shooter can also indicate whether electronic claims are expected to be submitted by selecting the Electronic Claims checkbox 1227 (service providers are encouraged to submit claims in electronic format because electronic claims are less likely to be lost than non-electronic claims and are therefore more likely to be paid reliably). By integrating the claims acquisition tool with the scheduling and adjudication tools described above, problem claims are more likely to be identified and resolved in a timely fashion.

### Methods and Systems for Accessing Patient History Information Using a Human Body Graphical User Interface

A human body graphical user interface (GUI) for accessing medical care history information for a patient is described herein that can be employed in conjunction with stand-alone systems or methods in a health services environment, or in conjunction with any or all aspects of the systems and methods already described herein for determining the appropriateness of service provider claims and/or for tracking treatment of patients. As will be described in more detail herein, in one embodiment, the human body GUI can be used to access and display the medical care history information for a patient (and/or for a population of patients) as graphically-formatted content instead of, or addition to, text-formatted content, enabling a user, such as the patient, a medical service provider or an organization to understand the patient's medical care history at a glance, without having to read the textually-formatted content. Additionally, in another embodiment, portions of the graphically-formatted content are selectable, enabling a user to filter the patient's medical care history information, for example, to concentrate on a particular portion of the human body. In other embodiments, multiple instances of the human body GUI can be displayed to view medical care history information for different periods of time during which a patient is receiving care and/or to view the medical care history information of more than one patient at a time.

These and other exemplary embodiments are presented in detail in the description that follows. Persons skilled in the relevant art(s) will understand that the embodiments described herein need not be limited to health services environments for humans. That is, the embodiments can be adapted for use in animal health services environments (e.g., a cat clinic) where the patients are animals and the GUI is adapted to the form of a particular animal.

Detailed Description of Exemplary Process

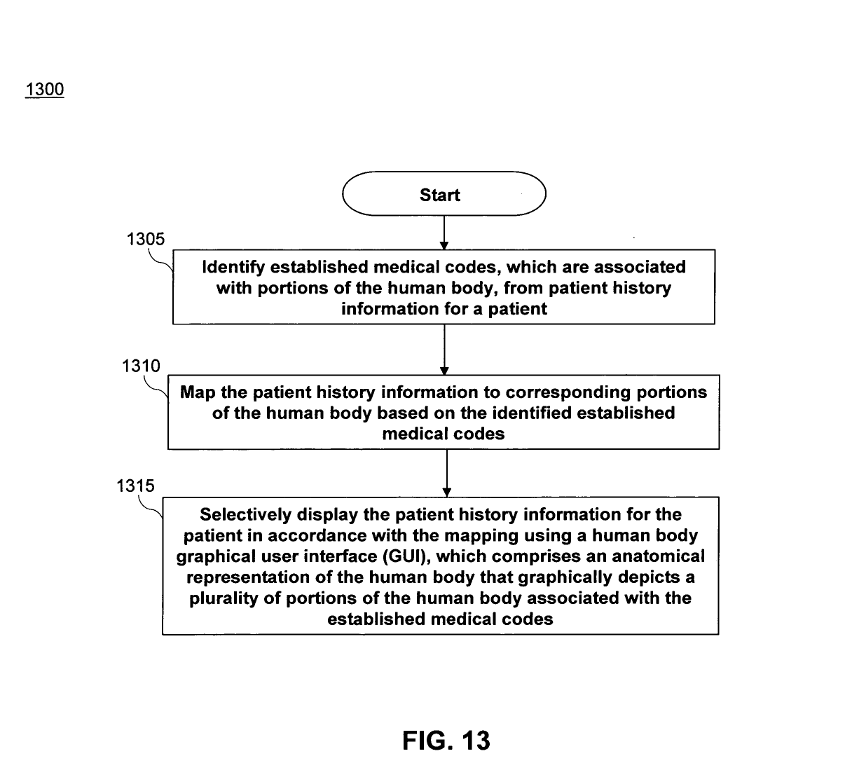

FIG. 13 illustrates exemplary steps for a process 1300 for accessing patient history information using a human body GUI. Not all of the steps of the figures have to occur in the order shown, as will be apparent to persons skilled in the relevant art(s) based on the teachings herein. Other operational and structural embodiments will be apparent to persons skilled in the relevant art(s) based on the following discussion. These steps are described in detail below and, as will be apparent to persons skilled in the relevant art(s), can be implemented in hardware, software, firmware, or combinations thereof.

In step 1305, established medical codes, which are associated with portions of the human body, are identified from patient history information for a patient. Exemplary established medical codes include, but are not limited to, the International Classification of Diseases (ICD-9) diagnostic codes, the Healthcare Common Procedure Coding System (HCPCS), the Current Procedural Terminology (CPT) codes, as well as to any other existing or future established coding systems that define codes to uniquely classify medical conditions. Such codes or combinations of such codes can be used in health services environments to identify services requested and services performed. For example, as described herein, when scheduling an appointment for a patient, a scheduler can select appointment information from predefined menus of appointment information, which includes, in one embodiment a unique service identifier code 1021, as shown in FIG. 10B, for each requested service that can be used as a cross-check against Medicare-defined service codes to validate subsequently received claims for the services performed.

Thus, the established medical codes can be included in and subsequently identified from various types of patient history information. The patient history information can be compiled from appointment information and/or service information for particular patients. For example, as described herein in reference to FIG. 9, the system for determining the appropriateness of service provider claims for payment can include a scheduling module configured to schedule appointments for patients with the service providers 910 based on requests for services from the client institution 905, and generate appointment information corresponding to each of the scheduled appointments. The system can further include a claim intake module configured to receive claims from the service providers 910 for payment of charges associated with services rendered by the service providers 910 to the patients and capture service information corresponding to each of the received claims. The appointment information and the service information can be stored in the database 925. Subsequently, the stored appointment and/or claim information can be imported from the database 925 for use in the process 1300 for accessing patient history information using the human body GUI. Persons skilled in the relevant art(s) will understand that the patient history information can be imported and compiled for use in the process 1300 from other sources, as well, and need not be limited to the configuration illustrated in FIG. 9.

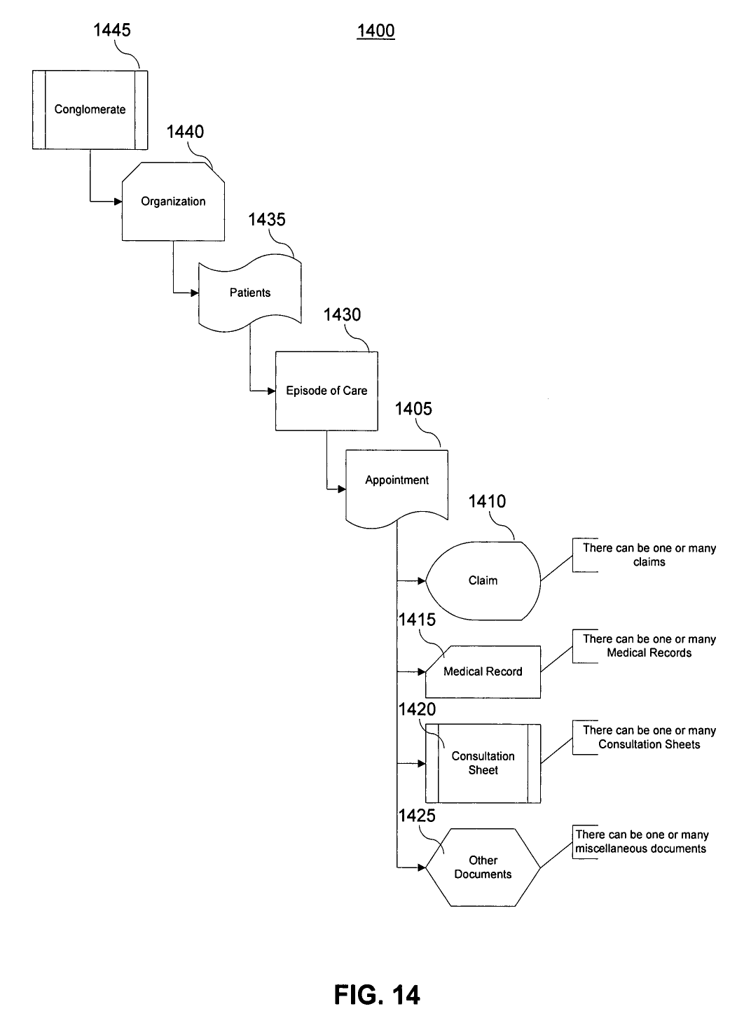

As shown in FIG. 14, in one embodiment, the patient history information can be structured in a hierarchy 1400 that includes appointment information corresponding to at least one appointment 1405 for the patient that was scheduled with one or more service providers (e.g., physicians, hospitals, medical groups, etc.) based on a request for services. The patient history information can also include service information corresponding to one or more claims 1410 received from the service providers for payment of charges associated with the services rendered by the service providers to the patient for the scheduled appointment 1405. The patient history information can further include one or more consultation sheets 1415, such as the consultation sheet 1039, illustrated in FIG. 10D, medical records 1420, and other documents 1425, such as patient drug history, immunization status, and/or laboratory test results, pertaining to the scheduled appointment 1405. The claim(s) 1410, consultation sheet(s) 1415, medical record(s) 1420 and other document(s) 1425 can be linked to the scheduled appointment 1405, as shown in FIG. 14.

Optionally, the patient history information can include episode of care information for an episode of care 1430 pertaining to treatment of a specified medical condition. The episode of care 1430 can include one or more of the scheduled appointments 1405 that correspond to the treatment of the specified medical condition. As shown in FIG. 14, the hierarchy 1400 of patient history information can also include patient history information for a plurality of patients 1435, for an organization 1440 that comprises a population of the plurality of patients 1435, such as a hospital, medical group, academic campus, correctional facility, rehabilitation facility, health care practitioner, among others, and/or for a conglomerate 1445 that comprises a plurality of the organizations 1440 having associated patient populations, such as an HMO, among others. Persons skilled in the relevant art(s) will understand that the exemplary patient history information hierarchy 1400 illustrated in FIG. 14 can be configured to include other levels of information, as well as one or more interconnections between the different levels.

In step 1310 of the process 1300, illustrated in FIG. 13, the patient history information is mapped to corresponding portions of the human body based on the identified established medical codes. For example, in one embodiment, the mapping of the ICD-9 diagnostic codes can be used to correlate the patient history information included in a claim to a particular body area. For example, if a claim includes an ICD-9 code for “fracture of humerus” and an ICD-9 code for “fracture of rib(s),” then the claim can be mapped to both the arm and the chest portions of the human body.

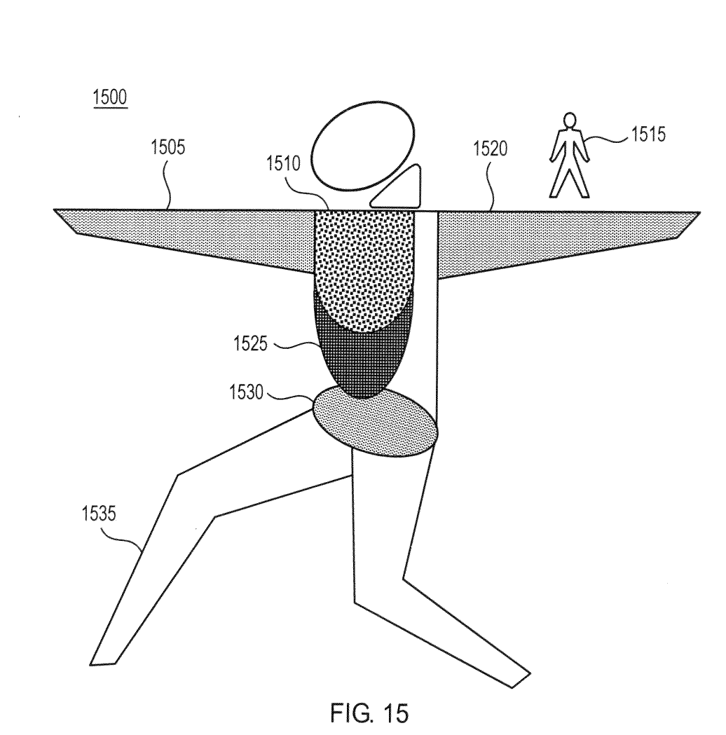

Subsequently, in step 1315, the patient history information for the patient is displayed in accordance with the mapping using a human body GUI, which comprises an anatomical representation of the human body that graphically depicts a plurality of portions of the human body associated with the established medical codes. FIG. 15 illustrates an exemplary human body GUI 1500 that graphically depicts head, neck, arm, chest, back, abdomen, pelvis and leg portions of the human body. As described herein, established medical codes used in claims to classify medical conditions of a patient are associated with these portions of the human body. In the previous example, the claim information for the patient is mapped to the arm and chest portions of the human body because the ICD-9 code for “fracture of humerus” is associated with the arm portions, while the ICD-9 code for “fracture of rib(s)” is associated with the chest portion.

In an embodiment, in step 1315, corresponding medical conditions of the patient are indicated on portions of the human body GUI in accordance with the mapping. For instance, in the previous example, the arm fractures can be indicated on the arm portions 1505 and 1520 of the human body GUI 1500 by illuminating (e.g., highlighting) the arm portions 1505 and 1520, as shown in FIG. 15. Similarly, the rib fractures can be indicated on the chest portion 1510 of the human body GUI 1500 by highlighting the chest portion 1510, as shown in FIG. 15.

In an embodiment, the established medical codes, such as the ICD-9 codes, can be assigned a severity level. Thus, in step 1315, a severity level of the corresponding medical conditions of the patient can be indicated on the portions of the human body GUI 1500. For example, different severity levels can be indicated using different colors, such as red for highest severity, orange for medium severity, yellow for lowest severity, and blue for undefined level of severity. Persons skilled in the relevant art(s) will understand that other severity levels and other severity level graphical representations (e.g., different textures instead of different colors) can be used.

In an embodiment, in step 1315 of the process 1300, a higher severity level is indicated on the human body GUI 1500 when a predetermined combination of the medical conditions of the patient is identified in accordance with the mapping. For example, if a male over thirty-five years old is experiencing the medical conditions of motor skill degradation of medium severity and high blood pressure of medium severity, this combination of medical conditions may be indicative of the onset of a stroke. In this example, the motor skill and blood pressure medical conditions can be indicated on the corresponding portions of the human body GUI 1500 as having the highest severity level instead of the medium severity level. In another embodiment, in step 1315, a higher severity level can be indicated on the human body GUI 1500 when one or more of the medical conditions of the patient persists for a predetermined period of time (e.g., a longer than usual Average Length of Stay (ALOS)). For example, if a patient is experiencing the medical condition of vomiting for one day, the condition can be indicated on the corresponding portion of the human body GUI 1500 as having the lowest severity level. However, after the patient has been vomiting for two days, the condition can be indicated on the corresponding portion of the human body GUI 1500 as having the medium severity level because it might be indicative of a stomach ulcer. In this way, a service provider, such as a physician, can use the GUI 1500 to help isolate diagnoses by combining historical data with current data.

In an embodiment, the human body GUI 1500 includes a full-body indicator 1515, as shown in FIG. 15. For example, the full-body indicator 1515 can be a small representation the human body, among other representations. In this way, in step 1315 of the process 1300, a systemic medical condition of the patient (e.g., diabetes) that is not associated with single portions of the human body but rather with all portions of the human body, can be indicated on the full-body indicator 1515 of the human body GUI 1500. As described herein with respect to the other portions of the human body GUI 1500, the full-body indicator 1515 can be highlighted to indicate a systemic medical condition of the patient, and can also be highlighted in different colors to indicate different severity levels of the systemic medical condition.

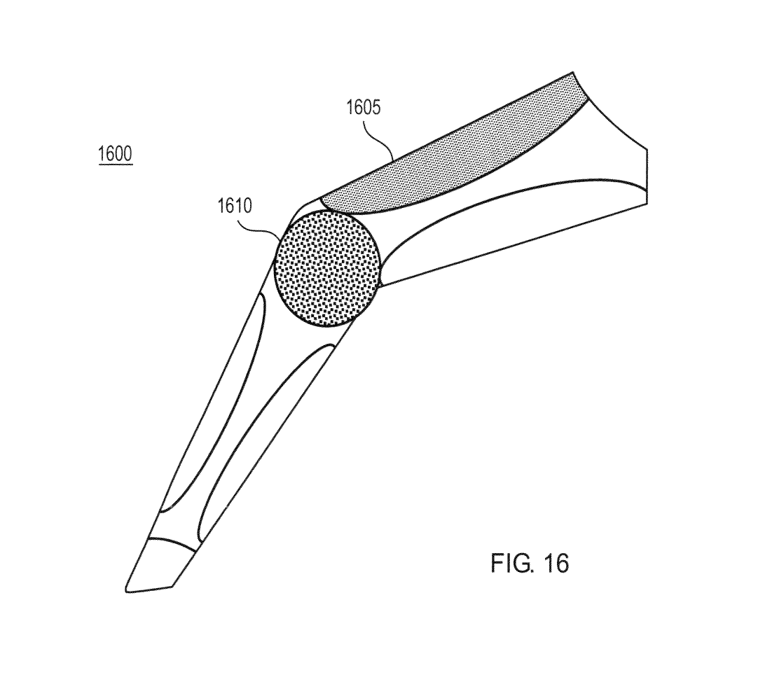

In an embodiment, the portions of the human body GUI 1500 are selectable to enable a user to access more detailed patient history information pertaining to a particular portion of the human body. For example, in step 1315 of the process 1300, in response to a user selecting one of the portions of the human body GUI 1500, a zoom-level human body GUI corresponding to the selected portion of the human body GUI is displayed. FIG. 16 illustrates a zoom-level human body GUI 1600 of a leg portion 1535 of the human body GUI 1500. The zoom-level GUI can be an anatomical representation of the corresponding selectable portion of the human body GUI that graphically depicts a plurality of portions of the corresponding selectable portion of the human body GUI associated with the established medical codes. In the example shown in FIG. 16, the zoom-level human body GUI 1600 is an anatomical representation of the leg portion 1535 of the human body GUI 1500 and includes portions that correspond to the established medical codes, such as a top thigh portion 1605, a knee portion 1610, etc.

In this way, in step 1315 of the process 1300, corresponding medical conditions of the patient can be indicated on portions of the zoom-level human body GUI 1600 in accordance with the mapping. As described herein with respect to the portions of the human body GUI 1500, the portions of the zoom-level human body GUI 1600 can be highlighted to indicate corresponding medical conditions of the patient, and can also be highlighted in different colors to indicate different severity levels of the corresponding medical conditions. For example, if the claim information for a patient includes the ICD-9 codes for “open wound of thigh” and “dislocation of knee,” the claim will not only be mapped to the leg portion 1535 of the human body GUI 1500 but also to top thigh portion 1605 and knee portion 1610 of the zoom-level GUI 1600. Thus, as shown in FIG. 16, the top thigh 1605 and knee 1610 portions of the zoom-level human body GUI 1600 can be highlighted to indicate the corresponding medical conditions thereof, and can also be highlighted in different colors to indicate different severity levels of the respective medical conditions.

The different portions of the human body GUI 1500 can each have different levels of granularity, enabling a user to “zoom in” and “zoom out” of a particular body system to isolate particular areas of interest. For example, as described herein, in step 1315 of the process 1300, in response to the leg portion 1535 of the human body GUI 1500 being selected, the zoom-level human body GUI 1600 can be displayed. Each of the portions of the zoom-level human body GUI 1600 of the leg portion 1535 can also be selectable so that in response to the knee portion 1610 being selected, a zoom-level human body GUI of the knee portion 1610 can be displayed. In this example, the zoom-level human body GUI of the knee portion 1610 can be an anatomical representation of the knee portion 1610 that graphically depicts a plurality of portions of the knee associated with the established medical codes, such as a patella portion, tendon portions, cartilage portions, etc. In this way, as described herein, the portions of the zoom-level human body GUI of the knee portion 1610 can be highlighted to indicate corresponding medical conditions of the patient, and can also be highlighted in different colors to indicate different severity levels of the corresponding medical conditions, in accordance with the mapping. The portions of the zoom-level human body GUI of the knee portion 1610 may or may not be selectable to provide additional levels of granularity. When a user is finished viewing the zoom-level GUI of the knee portion 1610, the zoom-level GUI of the leg portion 1535 and/or the human body GUI 1500 can be re-displayed.

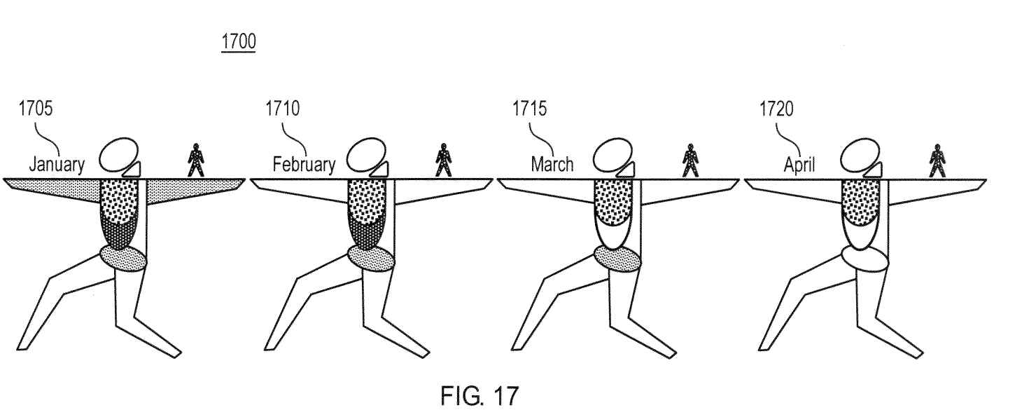

In an embodiment, in step 1315 of the process 1300, multiple instances of the human body GUI 1500 (or multiple instances of a zoom-level human body GUI, such as the zoom-level GUI 1600 of the leg portion 1535) can be displayed for the patient, where each instance of the GUI corresponds to a predetermined period of time during an episode of care 1430. In this way, a user can assess any changes in the medical condition(s) of the patient during the episode of care 1430. For example, FIG. 17 illustrates a GUI 1700 showing multiple instances 1705-1720 of the human body GUI 1500 for a four-month period of time (i.e., January to April), where each of the instances 1705-1720 indicates the corresponding medical condition(s) of the patient for a one-month period of time. In this example, the patient appears to be improving over the course of the four months because fewer medical conditions are indicated on the GUI 1720 for the month of April than are indicated on the GUIs 1705-1715 for the months of January, February and March. Persons skilled in the relevant art(s) will understand that more or less than four instances of the human body GUI 1500 (or of a zoom-level human body GUI) can be displayed, and that each instance can correspond to other predetermined time periods, such as one day, one year, etc.

In an embodiment, in step 1315 of the process 1300, multiple instances of the human body GUI 1500 (or the zoom-level human body GUI, such as the zoom-level human body GUI 1600 for the leg portion 1535) for a hypothetical patient can be displayed simultaneously in the GUI 1700 with the GUIs 1705-1720 for the patient. In this way, a user can make a side-by-side comparison between the actual changes in the specified medical condition(s) indicated on the GUIs 1705-1720 for the patient with expected changes in the specified medical condition(s) indicated on the GUIs for the hypothetical patient. This comparison can also be made with a demographic match of the patient (e.g., if the patient is a 40-year old woman, GUIs for another 40-year old woman can be simultaneously displayed) instead of with a hypothetical patient to assess how two independent patients in a patient population compare.

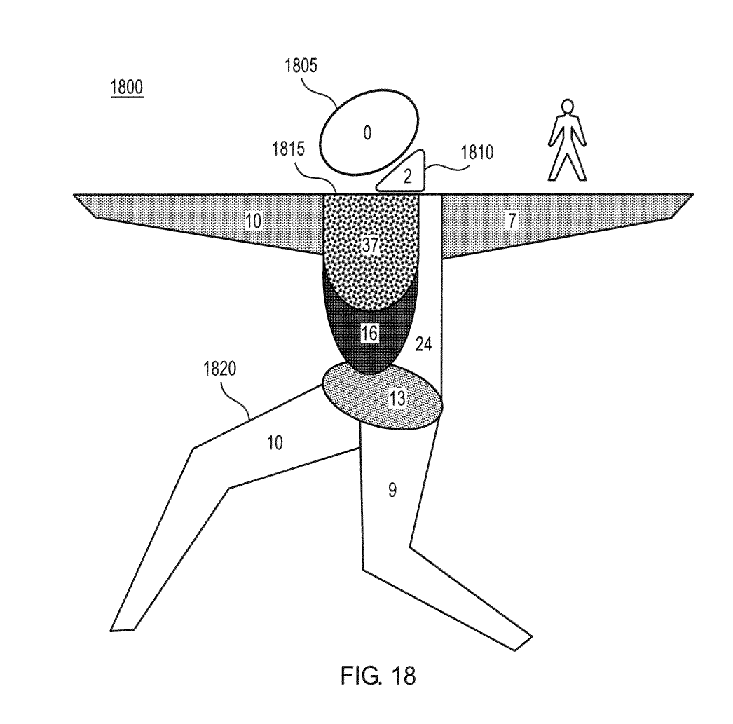

In an embodiment, in step 1315 of the process 1300, a cumulative representation of the patient history information for the patients within a patient population of an organization providing health care to the patients (e.g., a hospital, medical group, health care practitioner, etc.) is indicated on the portions of the human body GUI. For example, FIG. 18 illustrates a human body GUI 1800 for a population of patients of an organization 1440, where a cumulative representation of the patient history information for the patients within the patient population is indicated on the portions of the human body GUI 1800 as a number of claims. Also, as described herein, the portions of the human body GUI 1800 can be highlighted to indicate the corresponding medical conditions of the patient population. In one embodiment, severity levels of the corresponding medical conditions can also be indicated, for example, the claim numbers indicated on the portions of the human body GUI 1800 can be displayed in different colors according to different severity levels.

In the example illustrated in FIG. 18, a cumulative number of claims from the service providers pertaining to respective portions of the human body GUI 1800 are indicated for the patient population of the organization. For instance, zero claims pertaining to head portion 1805, two claims pertaining to neck portion 1810, thirty-seven claims pertaining to chest portion 1815, etc. are indicated. The cumulative representation need not be limited to the number of claims, for example, a number of times a particular facility of the organization was utilized (e.g., emergency room visits), a number of instances of a particular medical condition (e.g., stroke), a number of instances of a particular incident leading to an episode of care (e.g., automobile accidents), among other statistics pertaining to the respective portions of the human body GUI within the patient population can be indicated.

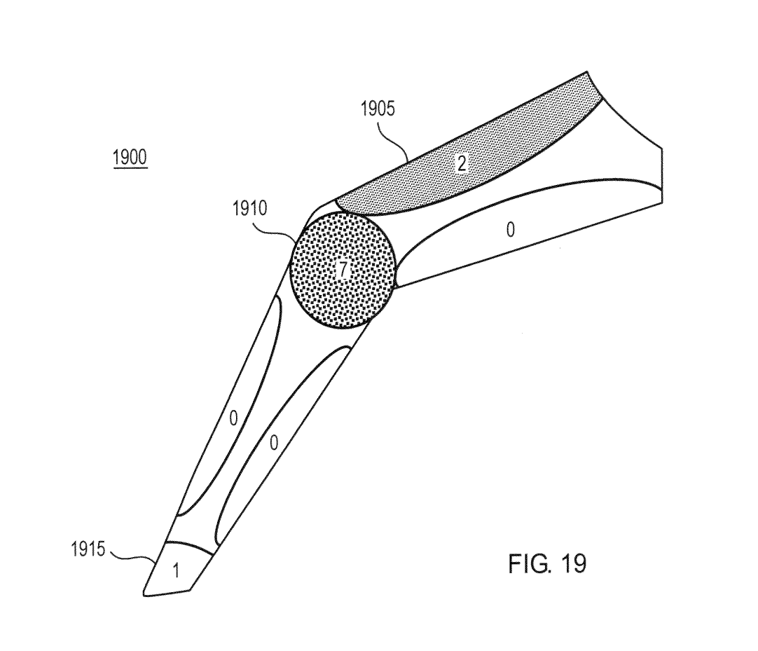

In this way, the organization can analyze the utilization of its facilities within a community, identify trends within the community regarding the occurrence of particular types of medical conditions, incidents leading to episodes of care, etc. Further, as described herein with respect to the human body GUI 1500, the portions of the human body GUI 1800 can also be selectable to display zoom-level human body GUIs for selected portions. For example, FIG. 19 illustrates a zoom-level human body GUI 1900 of a leg portion 1820 of the human body GUI 1800. The zoom-level human body GUI 1900 is an anatomical representation of the leg portion 1820 and includes portions that correspond to the established medical codes, such as a top thigh portion 1905, knee portion 1910, ankle portion 1915, etc.

Like human body GUI 1800, a cumulative representation of the patient history information for the patients within the patient population of the organization is indicated on the portions of the zoom-level human body GUI 1900. In the example illustrated in FIG. 19, a cumulative number of claims from the service providers pertaining to respective portions of the human body GUI 1900 are indicated for the patient population of the organization. For instance, two claims pertaining to top thigh portion 1905, seven claims pertaining to knee portion 1910, one claim pertaining to ankle portion 1915, etc. are indicated. Also, as described herein, the portions of the zoom-level human body GUI 1900 can be highlighted to indicate the corresponding medical conditions of the patient population. In one embodiment, severity levels of the corresponding medical conditions can also be indicated, for example, the cumulative claim numbers indicated on the portions of the human body GUI 1900 can be can be displayed in different colors according to different severity levels.

In an embodiment, in the step 1315 of the process 1300, a demographic of the patient population is selected and a cumulative representation of the patient history information for the patients within the selected demographic is indicated on the portions of the human body GUI 1800 or the zoom-level human body GUI 1900. For example, a cumulative number of claims from the service providers pertaining to respective portions of the human body GUI 1800 or the zoom-level human body GUI 1900 are indicated for the selected demographic (e.g., men over fifty, smokers, etc.).

In an embodiment, in step 1315 of the process 1300, a cumulative representation of the patient history information for a conglomerate 1445 comprising multiple organizations having associated patient populations (e.g., HMO, etc.) is indicated on the portions of the human body GUI. In this way, users at the conglomerate level can review the patient history information of the different organizations that they run. In an embodiment, the process 1300 includes the additional step of generating comparative reports for the conglomerate including, but not limited to, comparative utilization reports, comparative cost analysis, etc.

In an embodiment, the process 1300 includes the step of associating the patient history information of a first patient with the patient history information of a second patient. For example, the first and second patients might be members of the same family so that the patient history information of the first patient and the patient history information of the second patient comprise a family medical history. In this way, a service provider, such as a physician, can access the family medical history for a patient to help isolate diagnoses for the patient. In another embodiment, the immunization histories for the patients can also be accessed, enabling the service provider to determine whether any past immunizations may be affecting the current symptoms or conditions.

In an embodiment, the patient histories can be accessed through a web based application or a standalone application operating on a personal computer. For example, the patients might subscribe to a service whereby they agree to give third parties, such as physicians, access to their patient histories. In this way, multiple authorized parties can access a patient history at the same time and establish a secure chat room to discuss the patient's physical symptoms, etc.

In one embodiment, such a service can be accessed through a centralized intelligent database with business rules including a collection of all service providers and patients participating in the service. In another embodiment, the database can be specific to a particular client, so that the service would receive the claims from service providers for the patients and categorize them using the claim data provided on the claims. In this embodiment, appointments can be created for the received claims and the claims can be manually or automatically mapped to the appointments. Alternatively, if the methods and systems described herein for determining the appropriateness of service providers claims is employed, appointments are scheduled ahead of time and claims that correspond to the appointments are automatically identified. In either case, the appointment hierarchy 1400 illustrated in FIG. 1400 can be adopted, and the users of the service can be given the ability to modify the hierarchy.

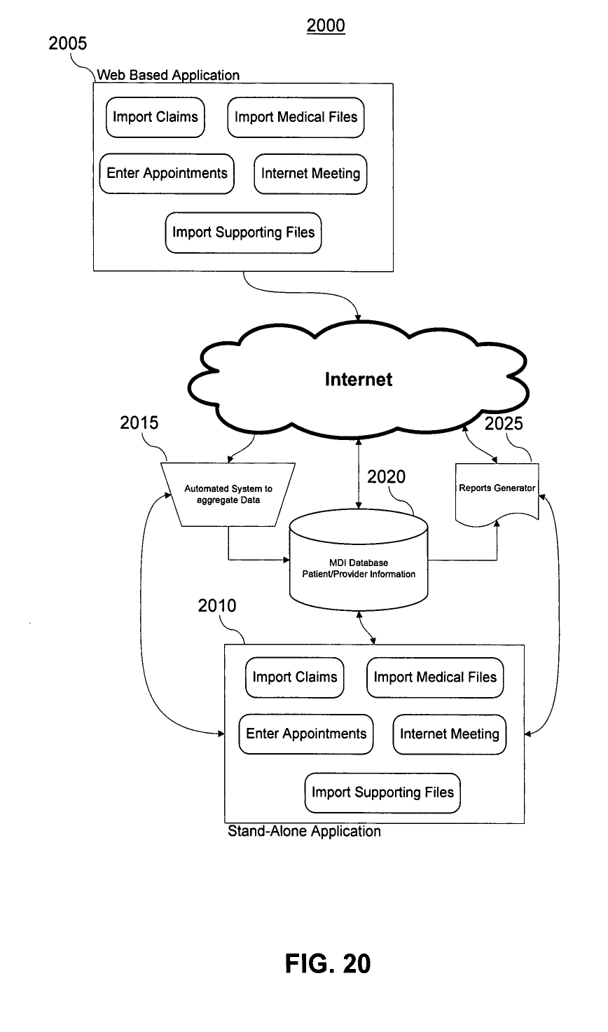

FIG. 20 illustrates a system diagram of an exemplary patient history information subscription service 2000. The service 2000 can include a web based application 2005 and/or a standalone application 2010 that include modules configured to import claims, enter appointments, import supporting files, import medical files, and support secure chat rooms (e.g., Internet meetings). The service 2000 also includes a data aggregation module 2015 configured to aggregate data, such as patient history information, service provider information, etc., a database 2020 that stores the aggregated data, and a reports generator module 2025 configured to create many types of reports based on the aggregated data (e.g., demographic information, human body system information, organization information, claim information, etc.) stored in the database 2020.

For example, the reports generator 2025 can generate a report that summarizes the costs for a particular patient associated with a particular episode of care or with medical conditions affecting a particular portion of the human body, etc., enabling service providers, as well as patients, to assess the associated costs. This type of report can also be used by organizations to calculate how much the health care for a particular patient is costing. In another example, the reports generator 2025 can generate a high-level utilization report showing the summation of the different human body systems, severities, and the cumulative claim counts. Such a report can be beneficial for organizations that are, at times, only responsible for covering a specified amount of the health care costs for a particular patient or group of patients. Thus, the service 2000 can enable organizations to view patient history information summaries for a particular patient or group of patients so that they can determine how much of the health care costs they are responsible for. In this way, organizations can track how much a particular patient or group of patients is costing them and better manage contractual obligations. The service 2000 can also enable organizations to set spending limits and view where particular patients stand with respect to the set spending limits. For example, patients' names can be color coded in accordance with their relationship to the set spending limit (e.g., red when the patient's health care costs exceed the limit, yellow when the patient's health care costs are within a particular amount of the limit, etc.).

Detailed Description of Exemplary Implementation

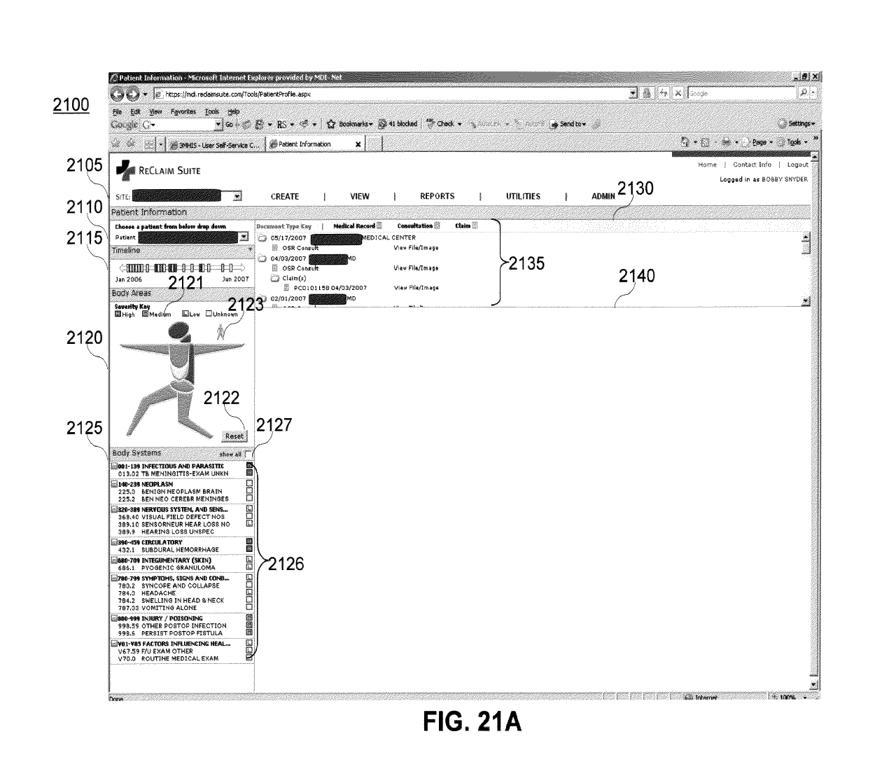

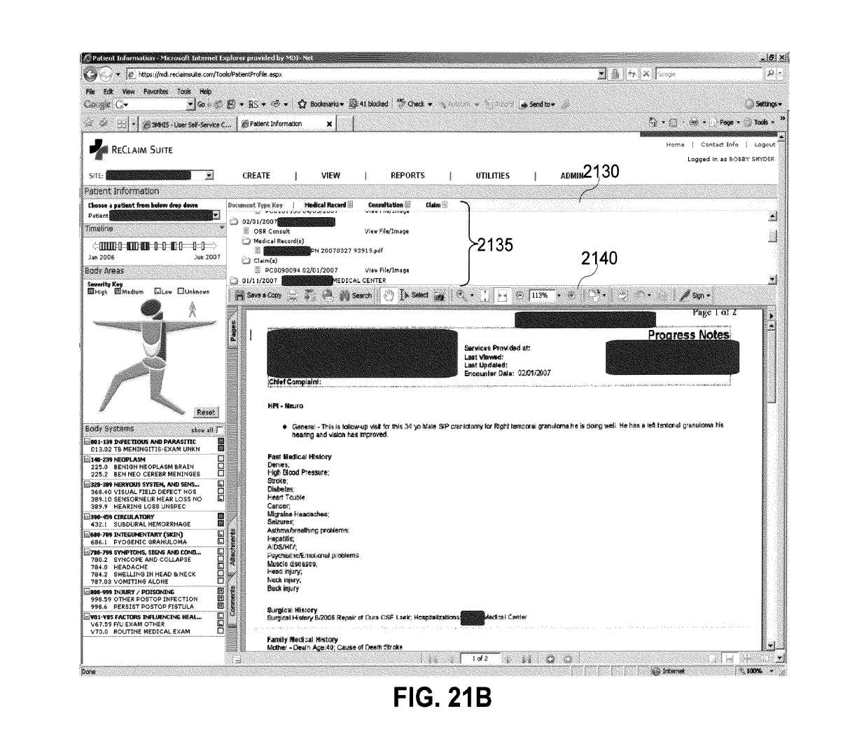

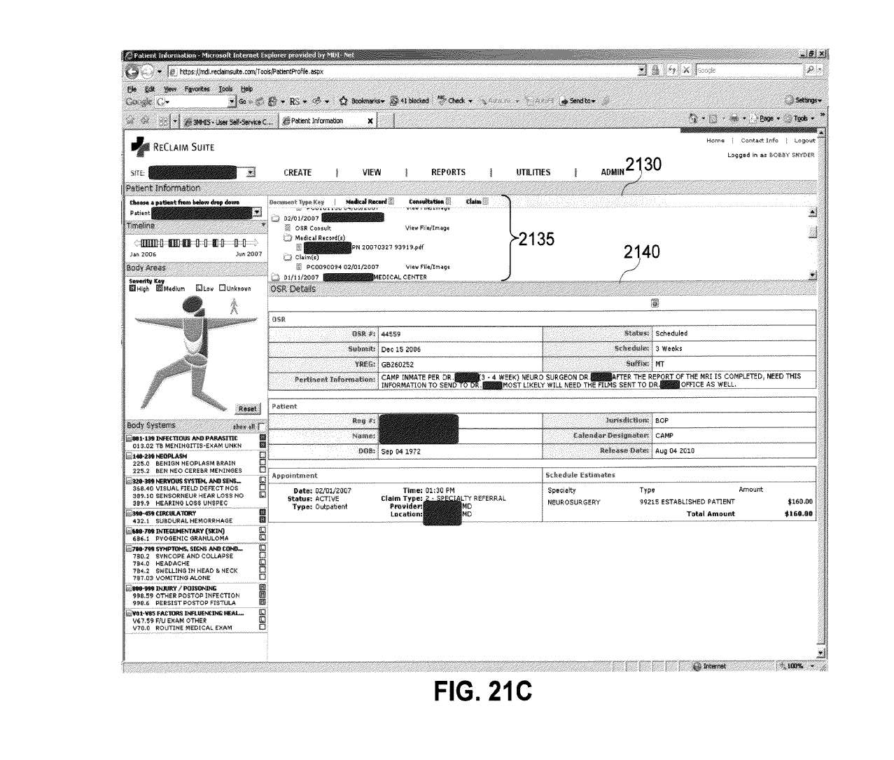

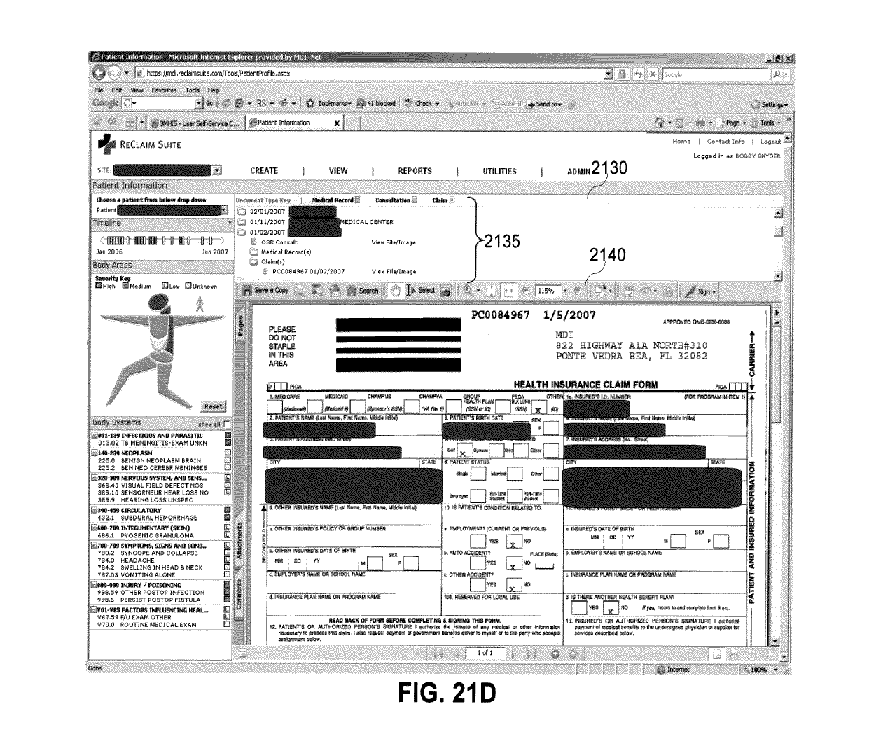

FIGS. 21A-21D illustrate screen captures of an exemplary implementation of the systems and methods described herein for accessing patient history information using a human body GUI. FIG. 21A illustrates a GUI 2100 that includes a site filter 2105, which can be implemented as a drop-down menu from which a user can select a particular organization (e.g., hospital, medical group, health care practitioner, etc.). Upon selection of a site, patient history information (e.g., appointment information, medical records, consultations, claims, etc.) is loaded for the selected site. The GUI 2100 also includes a patient filter 2110, which can be implemented as a drop-down menu from which a user can select a particular patient or group of patients from the patient population of the selected site.

As described herein, established medical codes (e.g., ICD-9 diagnostic codes) can be extracted from claims for services rendered to patient(s) and mapped to different body areas/body systems and assigned corresponding severity levels. To this end, the GUI 2100 further includes a human body GUI 2120, which can be configured with selectable body area portions from which a user can view zoom-level human body GUIs for the selected body area portion(s). In this way, a user can filter the patient history information for the selected patient(s) according to the selectable body area portions (e.g., legs, pelvis, back, abdomen, chest, head, neck and arms). The human body GUI 2120 also includes a selectable full-body indicator 2123, described herein, which indicates medical conditions affecting the entire body. The human body GUI 2120 further includes a severity key 2121, from which a user can ascertain a severity level of a medical condition indicated on a body area portion of the human body GUI 2120 (e.g., different colors can be used to indicate different severity levels, such as red for a high severity medical condition, orange for medium, yellow for low and blue for unknown level of severity).

The GUI 2100 also includes a listing of body systems 2125, which can be identified by ICD-9 diagnostic codes, among other diagnostic codes, identified from the patient history information for the selected patient(s). In this way, a user can filter the patient history information for the selected patient(s) according to the different body system groupings identified by ICD-9 codes. For example, by selecting the ICD-9 code “225.0 Benign Neoplasm Brain” in the body system grouping “140-239 Neoplasm,” a user can filter the patient history information for those appointments, medical records, consultations, claims, etc. pertaining to this particular medical condition. Optionally, a user can select a Show All checkbox 2127 to view not only the ICD-9 codes extracted from the patient history information for the selected patient(s), but all of the ICD-9 codes that are defined for a displayed body system grouping, whether or not they pertain to the patient history information for the selected patient(s). Like the human body GUI 2120, the body system listing 2125 can also include a severity key 2126 for each body system grouping and diagnostic code indicating, for example, an “H” for a high severity medical condition, “M” for medium, “L” for low and blank for unknown severity level.

The GUI 2100 also includes a timeline 2125 illustrating when each of the appointments identified for the selected patient(s) took place as appointment blocks. The appointment blocks in the timeline 2115 can be selectable so that a user can filter the patient history information in accordance with a selected appointment block. Additionally, a user can hover a cursor over an appointment block to view date and provider information for that appointment. Additionally, a user can select a Reset button 2122 to reset the patient history information for the selected patient(s). In this way, a user can reset any of the patient history information filters that the user may have previously applied.

Additionally, the GUI 2100 includes a window 2130 in which the appointment information for the selected patient(s) is displayed in a text format. The appointment information that is displayed corresponds to the level of granularity of the human body GUI 2120 and body system listing 2125 being displayed. That is, if a user zooms in on a particular body area portion of the human body GUI 2120 by selecting that portion, only the appointment information pertaining to the selected portion will be displayed in the window 2130. Similarly, if a user filters the patient history information by selecting a particular ICD-9 code from the body system listing 2125, only the appointment information pertaining to the selected body system/diagnostic code will be displayed in the window 2130.

In the example illustrated in FIG. 21A, the appointment information can be configured in a tree structure 2135, in which each appointment can be identified by appointment date and provider (provider name data has been redacted) and can have associated OSRs (i.e., a combination of a pre-authorization, consult and referral form, as described herein), claims, medical records, and/or any other documents, etc., that pertain to the appointment. In an embodiment, any of the listed items in the appointment tree structure 2135 can be selected and displayed in a window 2140. For example, in FIG. 21B, a medical record selected from the appointment information tree structure 2135 in window 2130 is displayed in the window 2140. In FIG. 21C, an OSR selected from the appointment information tree structure 2135 in window 2130 is displayed in the window 2140. In FIG. 21D, a claim selected from the appointment information tree structure 2135 in window 2130 is displayed in the window 2140.

As will be apparent to persons of skill in the relevant art(s), the GUI 2100 can be used for data gathering/mining. For example, in a medical records system, the GUI 2100 filters, described herein, can be used to determine, for a particular patient and/or population of patients, body areas and/or body systems most afflicted with medical conditions, a date range when a particular type of medical condition occurred (e.g., ankle injuries), how much a particular type of medical condition (e.g., back injuries) cost the selected site/organization, etc. Moreover, in another embodiment, the GUI 2100 can be used track drug history information for a selected site/patient population. For example, the GUI 2100 filters can be used to identify drug prescriptions, drug dosages, etc. associated with particular body areas and/or body systems. In yet another embodiment, the GUI 2100 can be used to analyze immunization history information for selected patients. For example, the GUI 2100 filters can be used to compare medical conditions affecting particular body areas and/or body systems for an immunized patient(s) with those affecting a non-immunized patient(s).

Further, the GUI 2100 filters can be used to visually separate appointments according to episodes of care, described herein (i.e., a course of treatment pertaining to a particular medical condition, such as, a knee injury, among others). Filtering the patient history information in accordance with episodes of care can be advantageous for analyzing the cost to a selected site/organization for particular episodes of care, and for generating corresponding episode of care reports. In this way, as described herein, organizations can better manage their contractual obligations by determining when they have met their responsibility for covering a specified amount of the health care costs for a particular patient or group of patients and/or when the health care costs for a particular patient(s) has exceed a preset spending limit.

### CONCLUSION

The present invention has been described with reference to several exemplary embodiments, however, it will be readily apparent to persons of skill in the relevant art(s) that it is possible to embody the invention in specific forms other than those of the exemplary embodiments described above. This may be done without departing from the spirit of the invention. These exemplary embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A computer-implemented method for accessing patient history information, comprising:
identifying established medical codes from patient history information for a patient, wherein the established medical codes are associated with portions of the human body;
mapping the patient history information to corresponding portions of the human body based on the identified established medical codes; and
displaying the patient history information for the patient in accordance with the mapping using a human body graphical user interface (GUI), wherein the human body GUI comprises an anatomical representation of the human body that graphically depicts a plurality of portions of the human body associated with the established medical codes.

2. The method of claim 1, wherein the step of displaying the patient history information comprises:
indicating on portions of the human body GUI corresponding medical conditions of the patient in accordance with the mapping.

3. The method of claim 2, wherein the step of indicating comprises:
illuminating the portions of the human body GUI.

4. The method of claim 2, further comprising:
indicating on the portions of the human body GUI a severity level of the corresponding medical conditions.

5. The method of claim 4, further comprising:
indicating on the human body GUI a higher severity level when a predetermined combination of the medical conditions or a predetermined duration of at least one of the medical condition is identified in accordance with the mapping.

6. The method of claim 2, wherein the human body GUI further comprises a full-body indicator, and wherein the step of displaying the patient information comprises:
indicating on the full-body indicator of the human body GUI a systemic medical condition of the patient in accordance with the mapping.

7. The method of claim 2, wherein the portions of the human body GUI are selectable and, in response to a user selecting one of the portions of the human body GUI, the step of displaying the patient history information further comprises:
displaying a first zoom-level human body GUI corresponding to the selected portion of the human body GUI, wherein the first zoom-level human body GUI comprises an anatomical representation of the corresponding selectable portion of the human body GUI that graphically depicts a plurality of portions of the corresponding selectable portion of the human body GUI associated with the established medical codes; and
indicating on portions of the first zoom-level human body GUI corresponding medical conditions of the patient in accordance with the mapping.

8. The method of claim 7, wherein the portions of the first zoom-level human body GUI are selectable and, in response to a user selecting one of the portions of the first zoom-level human body GUI, the step of displaying the patient history information further comprises:
displaying a second zoom-level human body GUI corresponding to the selected portion of the first zoom-level human body GUI, wherein the second zoom-level human body GUI comprises an anatomical representation of the corresponding selectable portion of the first zoom-level human body GUI that graphically depicts a plurality of portions of the corresponding selectable portion of the first zoom-level human body GUI associated with the established medical codes; and
indicating on portions of the second zoom-level human body GUI corresponding medical conditions of the patient in accordance with the mapping.

9. The method of claim 8, wherein, after displaying the first zoom-level human body GUI or the second zoom-level human body GUI, the step of displaying the patient history information further comprises:
re-displaying the human body GUI or the first zoom-level human body GUI, respectively.

10. The method of claim 8, wherein the step of displaying the patient history information further comprises:
simultaneously displaying the patient history information corresponding to the human body GUI or the zoom-level human body GUI in a textual format.

11. The method of claim 8, wherein the patient history information comprises appointment information corresponding to at least one appointment for the patient scheduled with one or more service providers based on a request for services.

12. The method of claim 11, wherein the patient history information further comprises at least one of a consultation sheet and medical record corresponding to the scheduled appointment.

13. The method of claim 11, wherein the patient history information further comprises at least one document corresponding to the scheduled appointment pertaining to at least one of drug history, immunization status, and laboratory test result information for the patient.

14. The method of claim 11, wherein the patient history information further comprises service information corresponding to one or more claims received from the service providers for payment of charges associated with the services rendered by the service providers to the patient for the scheduled appointment.

15. The method of claim 14, wherein the patient history information comprises episode of care information for an episode of care pertaining to treatment of a specified medical condition, and wherein the episode of care comprises a plurality of the scheduled appointments that correspond to the treatment of the specified medical condition.

16. The method of claim 15, wherein the step of displaying the patient history information comprises:
displaying a plurality of instances of the human body GUI or the zoom-level human body GUI for the patient, wherein each instance of the GUI corresponds to a predetermined period of time during the episode of care.

17. The method of claim 16, further comprising:
simultaneously displaying a plurality of instances of the human body GUI or the zoom-level human body GUI for a hypothetical patient to compare actual medical conditions of the patient with expected medical conditions of the hypothetical patient during the episode of care.

18. The method of claim 14, wherein the patient history information comprises patient history information for a plurality of patients.

19. The method of claim 18, further comprising:
selecting a demographic of the plurality of patients, wherein the step of displaying the patient information comprises indicating on the portions of the human body GUI or the zoom-level human body GUI a cumulative representation of the patient history information for the patients within the selected demographic.

20. The method of claim 19, wherein the step of displaying the patient history information comprises:
simultaneously displaying at least one instance of the human body GUI or the zoom-level human body GUI for a first patient within the selected demographic and at least one instance of the human body GUI or the zoom-level human body GUI for a second patient within the selected demographic.

21. The method of claim 18, wherein the step of displaying the patient information comprises:
indicating on the portions of the human body GUI or the zoom-level GUI a cumulative representation of the patient history information for an organization comprising a population of the plurality of patients.

22. The method of claim 21, wherein the step of indicating comprises:
indicating on the portions of the human body GUI or the zoom-level GUI a cumulative number of claims from the service providers pertaining to the respective portions of the human body GUI or the zoom-level GUI for the patients within the patient population.

23. The method of claim 21, further comprising:
indicating on the portions of the human body GUI or the zoom-level GUI a cumulative number of instances of a particular medical condition pertaining to the respective portions of the human body GUI or the zoom-level GUI for the patients within the patient population.

24. The method of claim 21, further comprising:
indicating on the portions of the human body GUI or the zoom-level GUI a cumulative number of instances of a particular incident leading to an episode of care pertaining to the respective portions of the human body GUI or the zoom-level GUI for the patients within the patient population.

25. The method of claim 21, further comprising:
indicating on the portions of the human body GUI or the zoom-level GUI a cumulative number of instances of usage of a particular facility of the organization pertaining to the respective portions of the human body GUI or the zoom-level GUI for the patients within the patient population.

26. The method of claim 21, wherein the step of displaying the patient information comprises:
indicating on the portions of the human body GUI or the zoom-level GUI a cumulative representation of the patient history information for a conglomerate comprising a plurality of the organizations having associated patient populations.

27. The method of claim 18, further comprising:
associating the patient history information for a first patient of the plurality of patients with the patient history information for a second patient of the plurality of patients.

28. A computer-implemented system configured to implement the method of claim 27, the system comprising:
a database configured to store the patient history information; and
a processor configured to process the patient history information stored in the database.

29. The system of claim 28, wherein the system is configured to enable secure access by the service providers to the processed patient history information for the first and second patients.

30. The system of claim 28, further comprising:
a reports generator configured to generate reports based on the processed patient history information.

31. A recording medium on which the method of claim 1 is recorded as a program code that can be executed by a processing device.

32. A computer-implemented system for accessing patient history information, comprising:
means for identifying established medical codes from patient history information for a patient, wherein the established medical codes are associated with portions of the human body;
means for mapping the patient history information to corresponding portions of the human body based on the identified established medical codes; and
means for displaying the patient history information for the patient in accordance with the mapping using a human body graphical user interface (GUI), wherein the human body GUI comprises an anatomical representation of the human body that graphically depicts a plurality of portions of the human body associated with the established medical codes.

33. The system of claim 32, wherein the displaying means is configured to indicate on portions of the human body GUI corresponding medical conditions of the patient in accordance with the mapping.

34. The system of claim 32, wherein the displaying means is configured to illuminate the portions of the human body GUI.

35. The system of claim 32, wherein the displaying means is configured to indicate on the portions of the human body GUI a severity level of the corresponding medical conditions.

36. The system of claim 35, wherein the displaying means is configured to indicate on the human body GUI a higher severity level when a predetermined combination of the medical conditions or a predetermined duration of at least one of the medical conditions is identified in accordance with the mapping.

37. The system of claim 32, wherein the human body GUI further comprises a full-body indicator, and wherein the displaying means is configured to indicate on the full-body indicator of the human body GUI a systemic medical condition of the patient in accordance with the mapping.

38. The system of claim 32, wherein the portions of the human body GUI are selectable and, in response to a user selecting one of the portions of the human body GUI, the displaying means is configured to:
display a first zoom-level human body GUI corresponding to the selected portion of the human body GUI, wherein the first zoom-level human body GUI comprises an anatomical representation of the corresponding selectable portion of the human body GUI that graphically depicts a plurality of portions of the corresponding selectable portion of the human body GUI associated with the established medical codes; and
indicate on portions of the first zoom-level human body GUI corresponding medical conditions of the patient in accordance with the mapping.

39. The system of claim 38, wherein the portions of the first zoom-level human body GUI are selectable and, in response to a user selecting one of the portions of the first zoom-level human body GUI, the displaying means is configured to:
display a second zoom-level human body GUI corresponding to the selected portion of the first zoom-level human body GUI, wherein the second zoom-level human body GUI comprises an anatomical representation of the corresponding selectable portion of the first zoom-level human body GUI that graphically depicts a plurality of portions of the corresponding selectable portion of the first zoom-level human body GUI associated with the established medical codes; and
indicate on portions of the second zoom-level human body GUI corresponding medical conditions of the patient in accordance with the mapping.

40. The system of claim 39, wherein, after displaying the first zoom-level human body GUI or the second zoom-level human body GUI, the displaying means is configured to re-display the human body GUI or the first zoom-level human body GUI, respectively.

41. The system of claim 39, wherein the displaying means is configured to simultaneously display the patient history information corresponding to the human body GUI or the zoom-level human body GUI in a textual format.

42. The system of claim 39, wherein the patient history information comprises appointment information corresponding to at least one appointment for the patient scheduled with one or more service providers based on a request for services.

43. The system of claim 42, wherein the patient history information further comprises at least one of a consultation sheet and medical record corresponding to the scheduled appointment.

44. The system of claim 42, wherein the patient history information further comprises at least one document corresponding to the scheduled appointment pertaining to at least one of drug history, immunization status, and laboratory test result information for the patient.

45. The system of claim 42, wherein the patient history information further comprises service information corresponding to one or more claims received from the service providers for payment of charges associated with the services rendered by the service providers to the patient for the scheduled appointment.

46. The system of claim 45, wherein the patient history information comprises episode of care information for an episode of care pertaining to treatment of a specified medical condition, and wherein the episode of care comprises a plurality of the scheduled appointments that correspond to the treatment of the specified medical condition.

47. The system of claim 46, wherein the displaying means is configured to display a plurality of instances of the human body GUI or the zoom-level human body GUI for the patient, wherein each instance of the GUI corresponds to a predetermined period of time during the episode of care.

48. The system of claim 47, wherein the displaying means is configured to simultaneously display a plurality of instances of the human body GUI or the zoom-level human body GUI for a hypothetical patient to compare actual medical conditions of the patient with expected medical conditions of the hypothetical patient during the episode of care.

49. The system of claim 45, wherein the patient history information comprises patient history information for a plurality of patients.

50. The system of claim 49, wherein the displaying means is configured to indicate on the portions of the human body GUI or the zoom-level human body GUI a cumulative representation of the patient history information for the patients within a selected demographic.

51. The system of claim 50, wherein the displaying means is configured to simultaneously display at least one instance of the human body GUI or the zoom-level human body GUI for a first patient within the selected demographic and at least one instance of the human body GUI or the zoom-level human body GUI for a second patient within the selected demographic.

52. The system of claim 49, wherein the displaying means is configured to indicate on the portions of the human body GUI or the zoom-level GUI a cumulative representation of the patient history information for an organization comprising a population of the plurality of patients.

53. The system of claim 51, wherein the displaying means is configured to indicate on the portions of the human body GUI or the zoom-level GUI a cumulative number of claims from the service providers pertaining to the respective portions of the human body GUI or the zoom-level GUI for the patients within the patient population.

54. The system of claim 52, wherein the displaying means is configured to indicate on the portions of the human body GUI or the zoom-level GUI a cumulative number of instances of a particular medical condition pertaining to the respective portions of the human body GUI or the zoom-level GUI for the patients within the patient population.

55. The system of claim 52, wherein the displaying means is configured to indicate on the portions of the human body GUI or the zoom-level GUI a cumulative number of instances of a particular incident leading to an episode of care pertaining to the respective portions of the human body GUI or the zoom-level GUI for the patients within the patient population.

56. The system of claim 52, wherein the displaying means is configured to indicate on the portions of the human body GUI or the zoom-level GUI a cumulative number of instances of usage of a particular facility of the organization pertaining to the respective portions of the human body GUI or the zoom-level GUI for the patients within the patient population.

57. The system of claim 52, wherein the displaying means is configured to indicate on the portions of the human body GUI or the zoom-level GUI a cumulative representation of the patient history information for a conglomerate comprising a plurality of the organizations having associated patient populations.
